(19) United States
(12) Patent Application Publication
(10) Pub. No.: US 2006/0282306 A1
(43) Pub. Date: Dec. 14, 2006

(54) Employee selection via adaptive assessment

(75) Inventor: Anne Thissen-Roe, Vancouver, WA (US)

Correspondence Address: KLARQUIST SPARKMAN, LLP, 121 SW SALMON STREET, SUITE 1600, PORTLAND, OR, 97204, US

(73) Assignee: Unicru, Inc.

(21) Appl. No.: 11/409,340

(22) Filed: Apr. 21, 2006

Related U.S. Application Data
(60) Provisional application No. 60/726,881, filed on Oct. 14, 2005.
(60) Provisional application No. 60/689,585, filed on Jun. 10, 2005.

(51) Int. Cl. G06F 11/34

(52) U.S. Cl. 705/11

(57) ABSTRACT

An employee can be selected (e.g., employee job performance can be predicted) via a predictive model. Items presented as part of an assessment can be chosen according to which has greatest predictive power. The next item to be presented can be selected based on imputation of inputs to the predictive model for items not yet presented. Expected reduction in estimated output variance can be calculated.

### CROSS-REFERENCE TO RELATED APPLICATIONS

This application claims the benefit of U.S. Provisional Patent Application No. 60/726,881 to Thissen-Roe entitled “Employee Selection via Adaptive Assessment” filed on Oct. 14, 2005, and U.S. Provisional Patent Application No. 60/689,585 to Thissen-Roe entitled “Employee Selection via Adaptive Assessment” filed on Jun. 10, 2005, both of which are hereby incorporated herein by reference.

### BACKGROUND

Predicting an employee's job performance can be done via a computer-based assessment administered to a candidate employee. However, improvements remain to be made in various areas. For example, even if an assessment is effective when completed, the assessment process may be considered too lengthy. In particular, the number of items presented to a candidate employee may be considered excessive. As a result, some candidate employees may decline to finish the assessment or lose interest. Thus, techniques for reducing the size of assessments are useful.

### SUMMARY

A candidate employee can be selected (e.g., the employee's job performance can be predicted) via adaptive assessment. For example, a model can be used to choose an item (e.g., question) to be presented during assessment. The model can be constructed with reference to measured performance data for employees. The item to be presented can be chosen based on answers to previous items during the assessment. The assessment can thus be tailored to the candidate employee.

Such a model can be a neural network or other artificial intelligence-based model.

The model can take a plurality of inputs (e.g., variables), but in some cases, a prediction can be made without all the inputs.

Determining which item to present can be done with reference to the predictive power of the item (e.g., choosing the most predictive remaining item). Such predictive power can be determined by applying random responses (e.g., based on observed distribution for collected responses) to the model. Expected reduction in estimated output variance can be calculated.

Items can be chosen and presented until a satisfactory result is obtained. For example, upon determining that the predictive power of remaining items falls below a certain threshold, additional items need not be presented.

Performance can be measured using any number of measurable job performance criteria.

The number of items presented during assessment can be reduced while maintaining a useful level of accuracy. In other scenarios, the number of items can be kept the same while increasing accuracy. Or, the size of an assessment can simply be reduced.

The foregoing and other features and advantages will become more apparent from the following detailed description of disclosed embodiments, which proceeds with reference to the accompanying drawings.

### BRIEF DESCRIPTION OF THE FIGURES

FIG. 1 is a block diagram of an exemplary system operable to employ adaptive assessment techniques.

FIG. 2 is a flowchart of an exemplary method of employing adaptive assessment techniques for use in a system such as that shown in FIG. 1.

FIG. 3 is a flowchart of an exemplary method of employing an adaptive assessment technique.

FIG. 4 is a block diagram of an exemplary system operable to indicate a next question to be presented to a candidate, based on current answers by the candidate.

FIG. 5 is a flowchart of an exemplary method of indicating a next question to be presented to a candidate.

FIG. 6 is a block diagram of an exemplary system operable to indicate a next question presented to a candidate via a predictive model.

FIG. 7 is a flowchart of an exemplary method of indicating a next question to be presented to a candidate after determining which question to present via a predictive model.

FIGS. 8A-8C are block diagrams of an exemplary system operable to determine an output with less than all inputs.

FIG. 9 is a flowchart of an exemplary method of calculating an output score with less than all questions having been answered.

FIGS. 10A-10C are block diagrams of an exemplary system operable to determine an output with less than all inputs via simulated answers.

FIG. 11 is a flowchart of an exemplary method of calculating an output score with less than all questions having been answered via application of simulated answers.

FIGS. 12A-12C are block diagrams of an exemplary system operable to determine expected reduction in variance if a question were to be administered, based on simulated answers and a constrained input.

FIG. 13 is a flowchart of an exemplary method of determining expected reduction in variance if a question were to be administered, based on simulated answers and a constrained input.

FIG. 14 is a block diagram of an exemplary system including a predictive model employing a trait predictor to provide an output.

FIG. 15 is a flowchart of an exemplary method of employing a trait predictor.

FIG. 16 is a block diagram of an exemplary system operable to choose between a next question from a trait predictor and a next non-trait predictor question.

FIG. 17 is a flowchart of an exemplary method of choosing between a next question from a trait predictor and a next non-trait predictor question.

FIG. 18 is a block diagram of an exemplary system operable to calculate reduction in variance if a next question for a trait predictor were to be asked in light of already having answers to one or more questions.

FIG. 19 is a flowchart of an exemplary method of determining reduction in variance if a next question for a trait predictor were to be asked in light of already having answers to one or more questions.

FIG. 20 is a block diagram of an exemplary embodiment of a neural network adaptive assessment system.

FIG. 21 is an exemplary user interface that can be presented by a neural network adaptive assessment system.

FIG. 22 is a flowchart of an exemplary method for use by a sequencer in a neural network adaptive assessment system.

FIG. 23 is an excerpt of an exemplary log for a neural network adaptive assessment system.

FIG. 24 is a flowchart of an exemplary method for calculating score by filling in missing values.

FIG. 25 is a block diagram of an exemplary neural network.

FIG. 26 is a flowchart of an exemplary method for employing a neural network to calculate a score.

FIG. 27 is a screen shot of an exemplary user interface for presenting score results.

FIG. 28 is a block diagram of an exemplary scenario involving a system before any items having been administered.

FIG. 29 is a block diagram of an exemplary scenario involving a system after one item has been administered.

FIG. 30 is a block diagram of an exemplary scenario involving a system after plural items has been administered.

FIG. 31 is a block diagram of an exemplary node of a neural network.

FIG. 32 is a flowchart of an exemplary method of administering an adaptive assessment.

FIG. 33 is a dataflow diagram of an exemplary system for administering an adaptive assessment.

FIG. 34 is an illustration of an exemplary screen phone.

FIG. 35 is a block diagram of an exemplary suitable computing environment for implementing described implementations.

### DETAILED DESCRIPTION

### Example 1

### Exemplary System Employing the Technologies

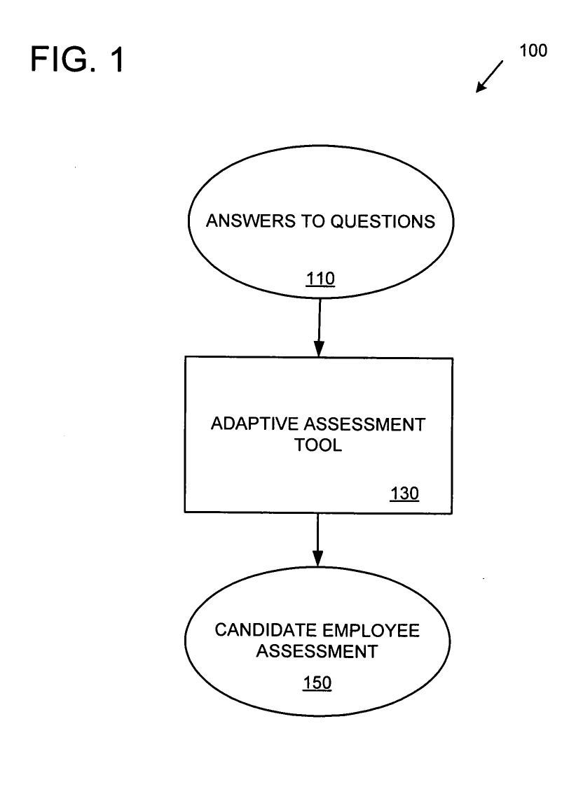

FIG. 1 is a block diagram of an exemplary system 100 operable to employ any of the adaptive assessment techniques described herein. In the example, an adaptive assessment tool 130 receives answers 110 to questions by a candidate being administered the assessment. Based on the answers 110 to the questions, the adaptive assessment tool 130 outputs a candidate employee assessment result 150.

The adaptive assessment tool 130 can include a predictive model (e.g., any model, such as a neural network, operable to accept inputs (e.g., answers 110) and output a candidate employee assessment result (e.g., the assessment result 150)).

Such an assessment result can be an indication of an output score useful for determining whether to hire a candidate such as one or more predicted job-performance criteria, an indication of whether to hire the candidate (e.g., a yes/no or yes/no/maybe result), or a combination thereof.

### Example 2

### Exemplary Method Employing the Technologies

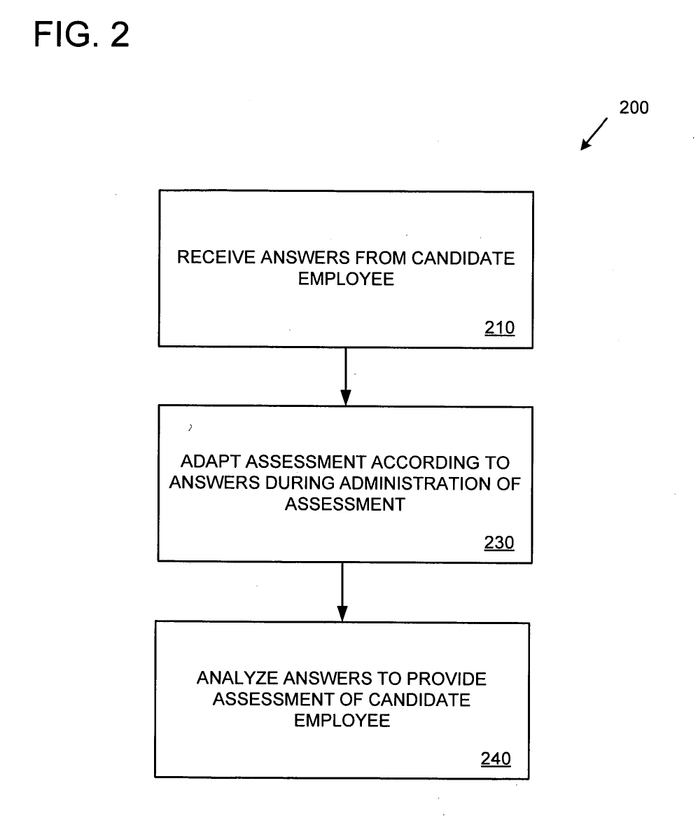

FIG. 2 is a flowchart of an exemplary method 200 of employing adaptive assessment techniques for use in a system such as that shown in FIG. 1. At 210, one or more answers from a candidate employee are received. At 230, the assessment is adapted according to the answers during administration of the assessment. For example, the next question to be asked can be selected during the assessment based on the answers already given during the assessment.

At 240, the answers are analyzed to provide an assessment of the candidate employee. In practice, the analyzing 240 and the adapting 230 can be performed together (e.g., in the process of adapting the assessment, a score indicating an assessment result can be calculated).

### Example 3

### Exemplary System Employing Personality Testing

In any of the examples herein, personality testing can be included as part of the assessment. For example, the questions can include those designed to assess personality, correlated with personality, or both. Adaptive testing for personality can be achieved by applying any of the techniques herein, such as choosing, during the assessment, a next question based on answers already given during the assessment.

### Example 4

### Exemplary Method Employing Adaptive Assessment Technique

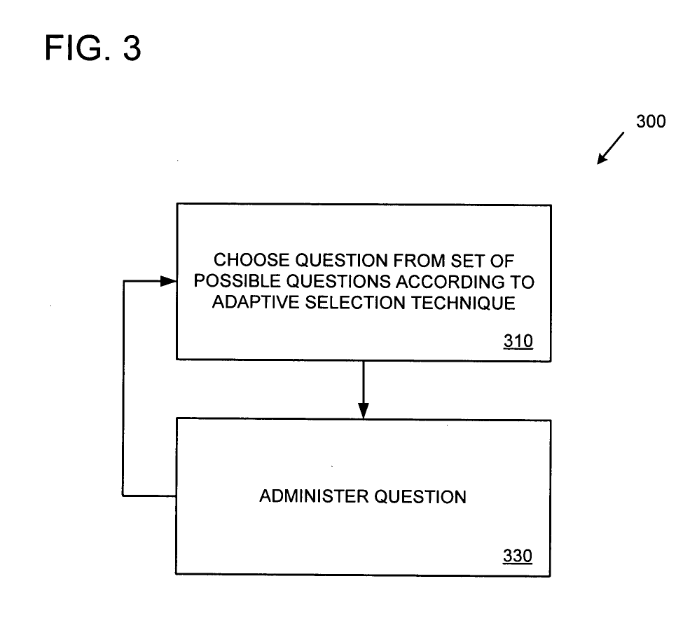

FIG. 3 is a flowchart of an exemplary method 300 of employing an adaptive assessment technique. At 310, a question is chosen from a set of possible questions according to an adaptive question selection technique. At 330, the question is administered to obtain additional answers from the candidate.

As described herein, additional questions can be administered until a stopping condition is met.

### Example 5

### Exemplary Adaptive Question Selection Technique

In any of the examples herein, any of a variety of adaptive question selection techniques can be used. For example, a next question can be chosen during administration of an assessment based on the predictive power of the question (e.g., in light of one or more other answers already obtained).

Predictive power can be quantified as an expected reduction in variance of an output (e.g., from an adaptive assessment tool) (e.g., in view of one or more other answers already obtained). As described herein, the expected reduction in variance can be estimated in a variety of ways.

### Example 6

### Exemplary System Selecting Next Question

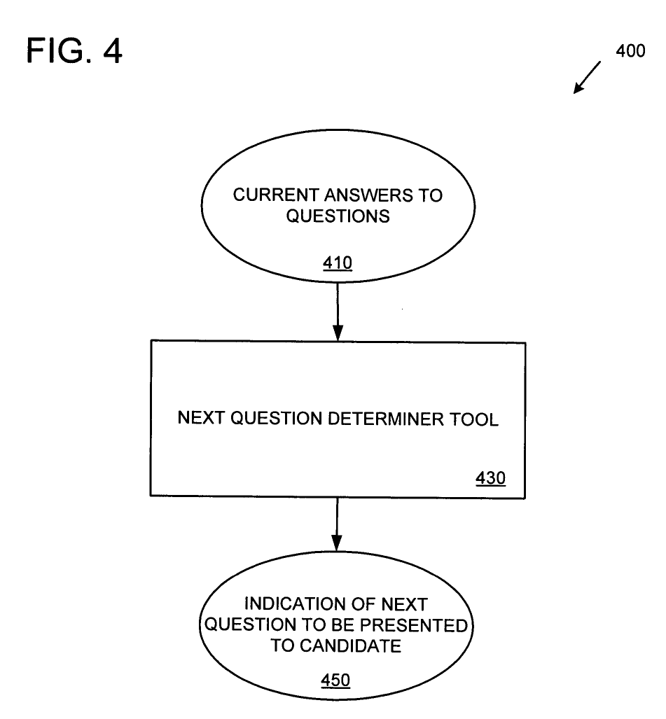

FIG. 4 is a block diagram of an exemplary system 400 operable to indicate a next question to be presented to a candidate based on current answers 410 by the candidate and can be used in any of the examples herein. The next question determiner tool 430 (e.g., sometimes called a “sequencer”) receives current answers 410 to one or more questions. In some implementations, the tool 430 need not directly receive the answers. For example, some other mechanism accessible by the tool 430 may store the answers.

Based on the current answers 410 to the questions, the tool 430 outputs an indication 450 of the next question to be presented to the candidate. In some implementations, the tool 430 can delegate the task of determining the next question to another mechanism, which provides the output.

### Example 7

### Exemplary Method of Selecting Next Question

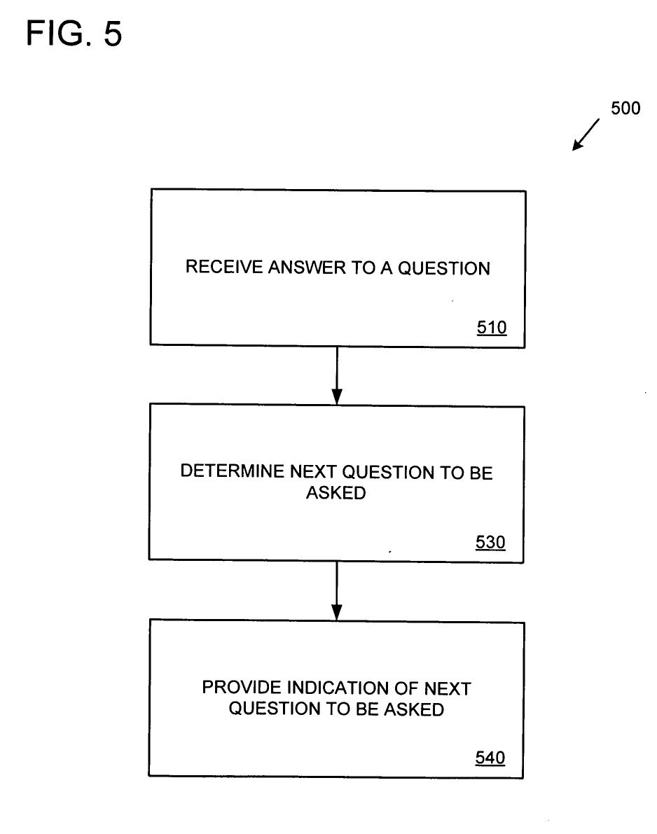

FIG. 5 is a flowchart of an exemplary method 500 of indicating a next question to be presented to a candidate. At 510, an answer to a question is received. At 530, the next question to be asked is determined (e.g., via any of the techniques described herein such as determining predictive power, reduction in variance, and the like). At 540 an indication of the next question to be asked is provided.

### Example 8

### Exemplary System Selecting Next Question Via Predictive Model

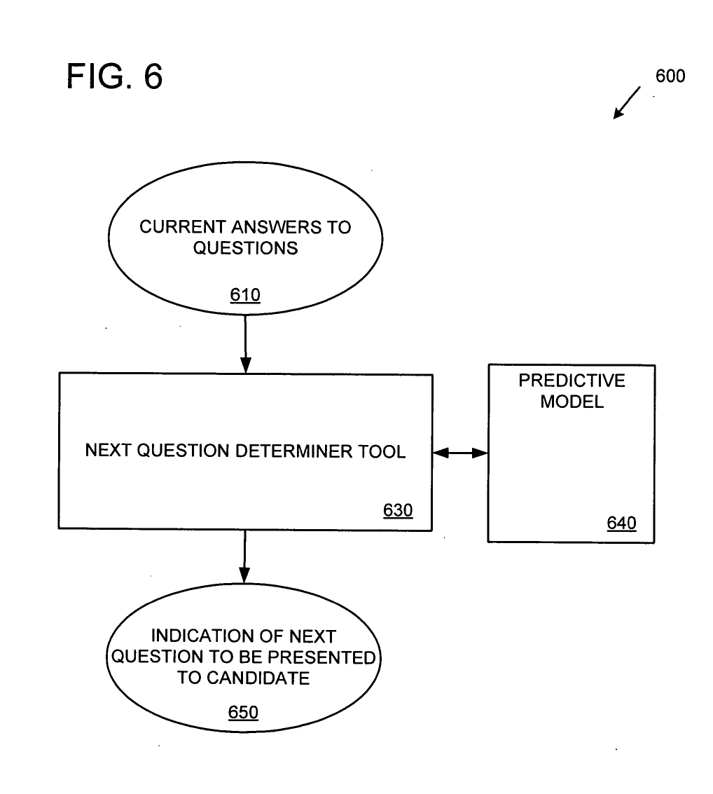

FIG. 6 is a block diagram of an exemplary system 600 operable to indicate a next question to be presented to a candidate based on current answers 610 by the candidate via a predictive model 640 and can be used in any of the examples herein. The next question determiner tool 630 (e.g., sometimes called a “sequencer”) receives current answers 610 to one or more questions. In some implementations, the tool 630 need not directly receive the answers. For example, some other mechanism accessible by the tool 630 may store the answers.

Based on the current answers 610 to the questions and via the predictive model 640, the tool 630 outputs an indication 650 of the next question to be presented to the candidate. In some implementations, the tool 630 can delegate the task of determining the next question to another mechanism, which provides the indication.

The predictive model 640 can be any model operable to accept inputs (e.g., answers 610) and output a candidate employee assessment result.

### Example 9

### Exemplary Method Selecting Next Question Via Predictive Model

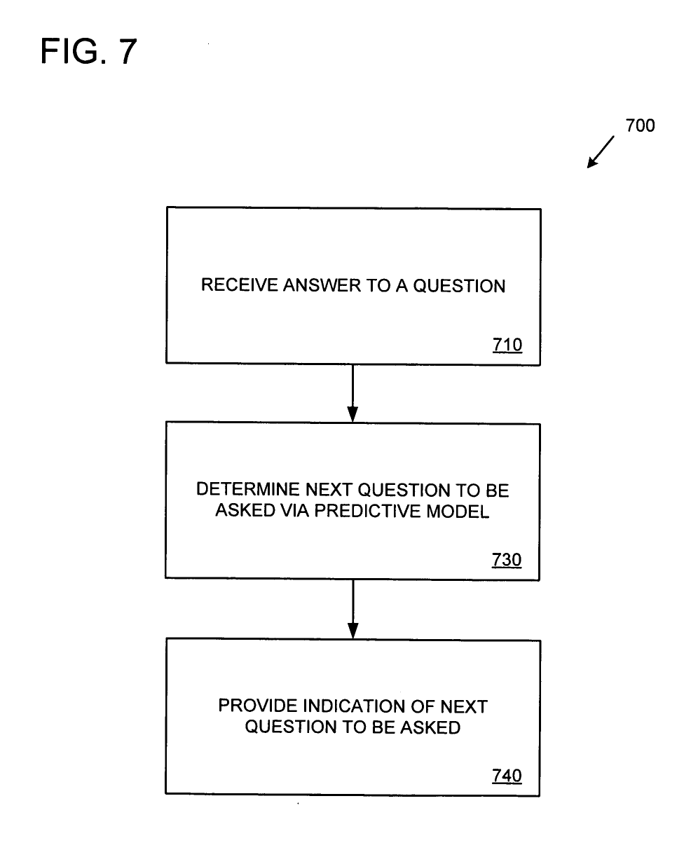

FIG. 7 is a flowchart of an exemplary method 700 of indicating a next question to be presented to a candidate after determining which question to present via a predictive model. At 710, an answer is received to a question. At 730, the next question to be presented to the candidate is determined via the predictive model. At 740, an indication of the next question to be asked is provided.

In practice, the next question can then presented to the candidate, who indicates an answer.

### Example 10

### Exemplary System Determining an Output with Less than all Inputs

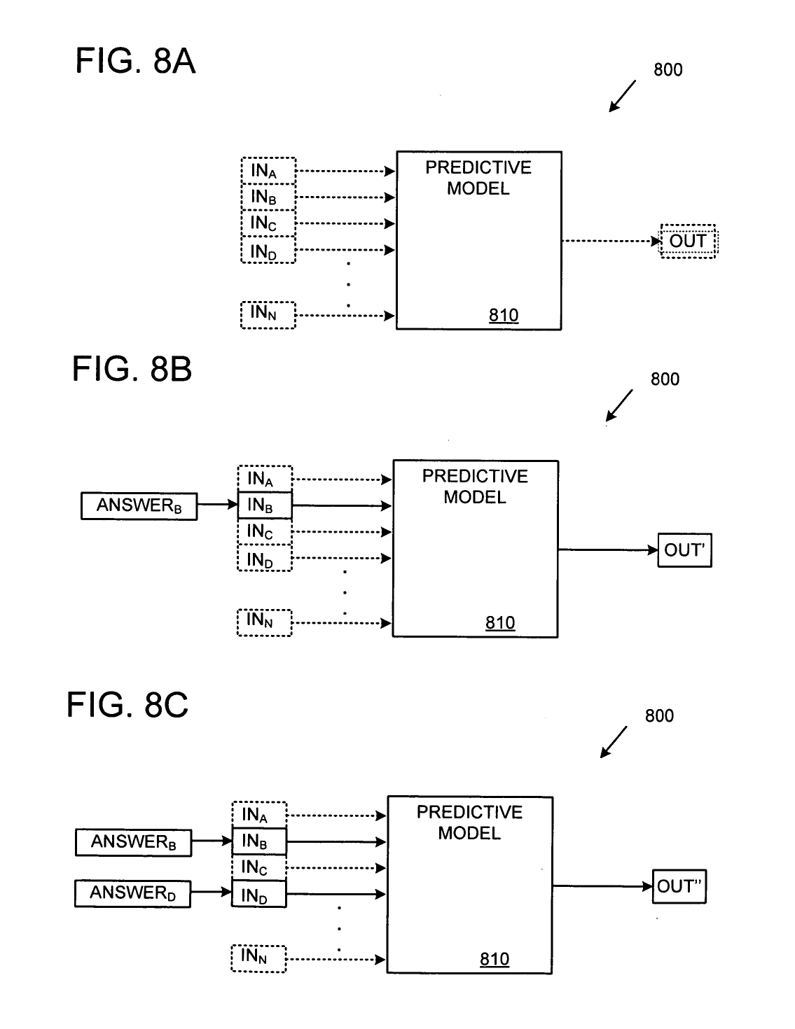

FIGS. 8A-8C are block diagrams of an exemplary system 800 operable to determine an output with answers for less than all inputs. The output OUT of the system 800 can be used as an assessment result in any of the examples herein.

In FIG. 8A, the model 810 has no answers for inputs, and thus does not provide any output OUT.

In FIG. 8B, the model 810 has one input (e.g., ANSWER_{B} for input IN_{B}). The output OUT′ indicates a value even though some inputs are missing.

In FIG. 8C, the model 810 has two inputs (e.g., ANSWER_{B} for input IN_{B} and ANSWER_{D} for input IN_{D}). The output OUT″ indicates a value even though some inputs are missing. Typically, the output for 8C is more accurate than that of 8B because more information is available for consideration by the model 810.

In practice, the output OUT need not be provided directly by the predictive model 810. For example, another mechanism can apply the inputs and evaluate the output OUT (e.g., over a set of simulated answers for missing inputs).

### Example 11

### Exemplary Method Determining of Calculating Output with Less than all Inputs

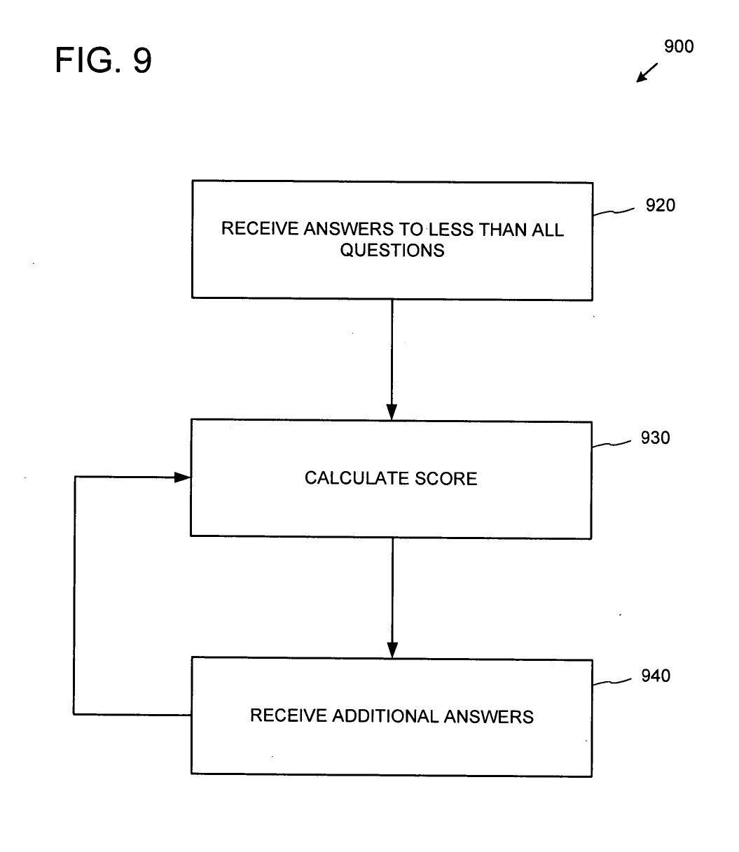

FIG. 9 is a flowchart of an exemplary method 900 of calculating an output with answers for less than all inputs. At 920, answers to less than all questions are received. At 930, an output (e.g., score) is calculated. At 940, additional answers can be received (e.g., as a result of selecting a next question via any of the techniques described herein and presenting the question) and the score can be calculated again. Processing can stop upon a stop condition as described herein.

### Example 12

### Exemplary System Determining an Output with Less than all Inputs

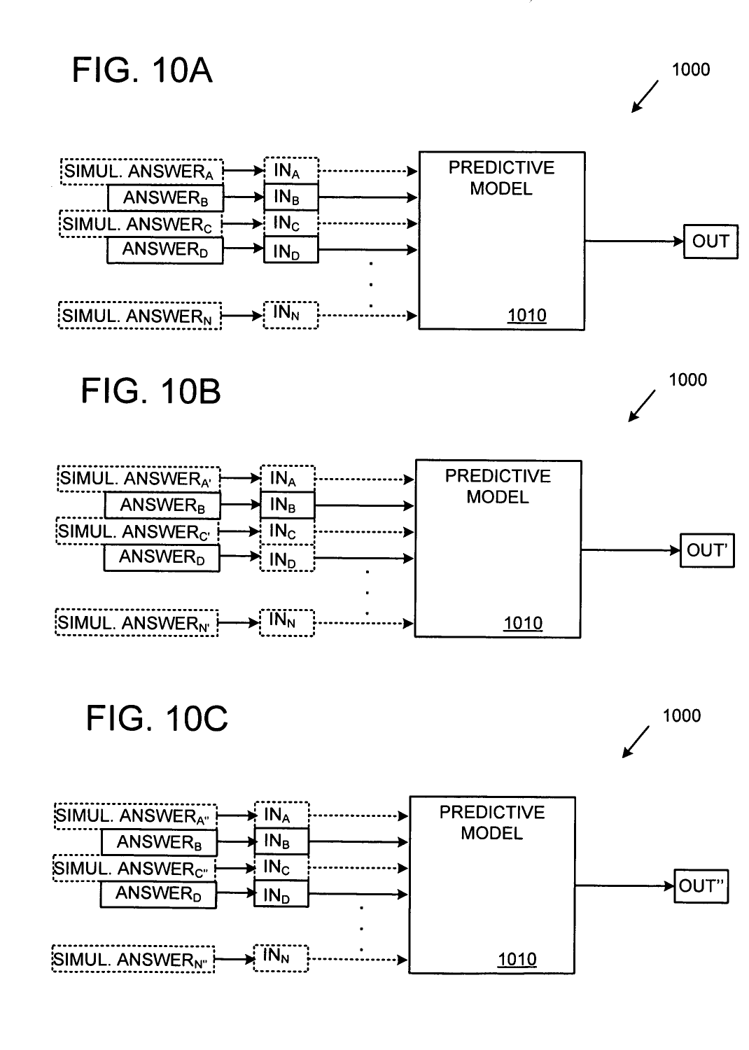

FIGS. 10A-10C are block diagrams of an exemplary system 1000 operable to determine an output with answers for less than all inputs via simulated answers. The output OUT of the system 800 can be used as an assessment result in any of the examples herein.

In FIG. 10A, some answers to questions have been provided by the candidate and are applied as inputs (e.g., ANSWER_{B} for input IN_{B} and ANSWER_{D} for input IN_{D}) of the model 1010. For the remaining inputs, IN_{A}, IN_{C}, and IN_{B}, simulated answers (e.g., plausible answers as described herein) are applied to the inputs. A resulting output OUT can be observed.

In FIG. 10B, different simulated answers are applied, and a perhaps different resulting output OUT′ can be observed.

In FIG. 10C, still different simulated answers are applied, and a perhaps different resulting output OUT″ can be observed.

Other techniques can be used, such as applying a same simulated answer for one input while varying answers applied to the other inputs, applying a different simulated answer for one input while varying answers applied to the other inputs, and so forth.

### Example 13

### Exemplary Method Determining an Output with Less than all Inputs

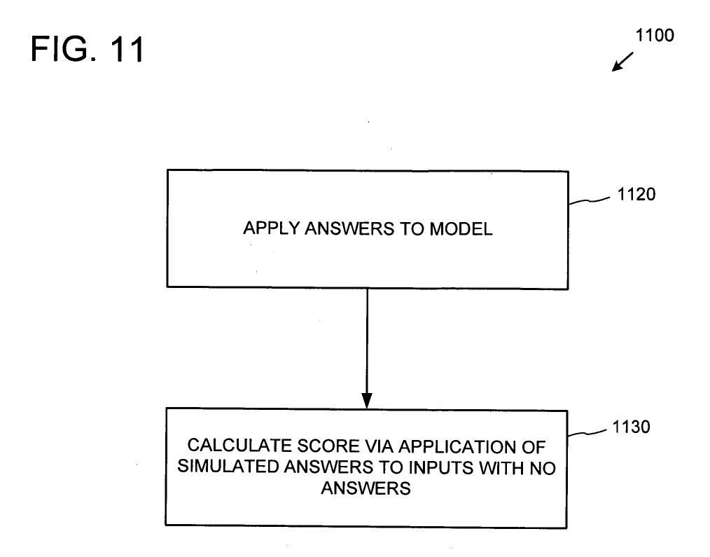

FIG. 11 is a flowchart of an exemplary method 1100 of calculating an output score with less than all questions having been answered via application of simulated answers. At 1120, answers provided by the candidate (e.g., actual answers) are applied to the model.

At 1130, the score is calculated by application of simulated answers to inputs for which the applicant has not provided an answer. Application of simulated answers can be performed repetitively (e.g., 10, 100, 1000, or more times) and a resulting score calculated based on the observed outputs (e.g., a mean, median, weighted mean, or the like). The score is sometimes called an “estimated score” because it is mathematically calculated to estimate the actual score of the applicant (e.g., the score if the remaining data were known).

### Example 14

### Exemplary Simulated Answers

In any of the examples herein, a variety of techniques can be employed to simulate answers. Any of the techniques described herein for plausible answers can be used to simulate answers. For example, simulated answers can be generated at random. Techniques can be used so that the random answers fall within the distribution of answers observed in past assessments. For example, a random value and a random percentage can be chosen. If the random percentage does not fall within the percentage distribution (e.g., expressed as a percentage) observed for the random value, the value can be discarded and another set of values chosen until the distribution test is satisfied.

### Example 15

### Exemplary System Determining Expected Reduction in Variance

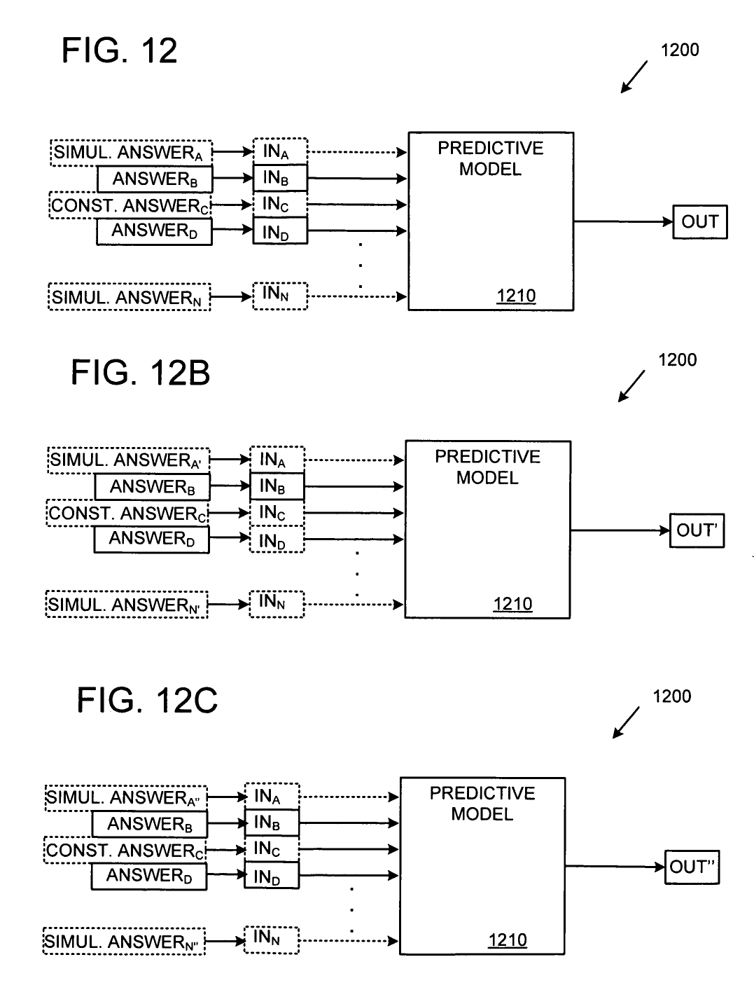

FIGS. 12A-12C are block diagrams of an exemplary system 1200 operable to determine reduction in variance if a question were to be administered based on simulated answers and a constrained input.

In FIGS. 12A-12C, answers have already been provided by the applicant and are applied as inputs (e.g., ANSWER_{B} for input IN_{B} and ANSWER_{D} for input IN_{D}) of the model 1210. Simulated answers are generated for inputs IN_{A} and IN_{N}. The input to IN_{C} is constrained (e.g., held to one or more constant values) while different simulated answers are generated. The resulting outputs (e.g., OUT, OUT′, and OUT″) can be observed. In this way, the variance in the output expected if an answer for IN_{C} were available can be calculated. The variance can be compared to the variance observed without constraining IN_{C}, so a reduction in variance if an answer for IN_{C} were available can be determined (e.g., by subtracting).

In practice, the variance is estimated (e.g., as an expected variance), and some other quantity can be used to represent variance or estimated variance. For example, standard error of mean (e.g., square root of the variance over the degrees of freedom), standard deviation (e.g., square root of the variance), or the like can be used. In some cases, a reduction of error can be used to represent reduction in variance.

### Example 16

### Exemplary Constraining

In any of the examples herein, constraining can be achieved by setting the values for a constrained input to possible values (e.g., answers) while simulated answers are generated for other inputs for which no answers by the candidate are yet available (e.g., while applying answers already obtained to appropriate inputs). An average variance can be calculated by averaging the variances observed for different responses for constrained input IN_{C} and weighting by the likelihood of the respective response. For example, if there are four possible values for IN_{C}, a weighted average can be computed of the variances obtained while the possible value of IN_{C} is held constant (e.g., a variance while IN_{C} is held to the first possible value, a variance while IN_{C} is held to the second possible value, a variance while IN_{C} is held to the third possible value, and a variance while IN_{C} is held to the nth possible value, etc.). For example, the weighted average can be based on the observed or expected distribution of the possible values.

### Example 17

### Exemplary Method of Determining Expected Reduction in Variance

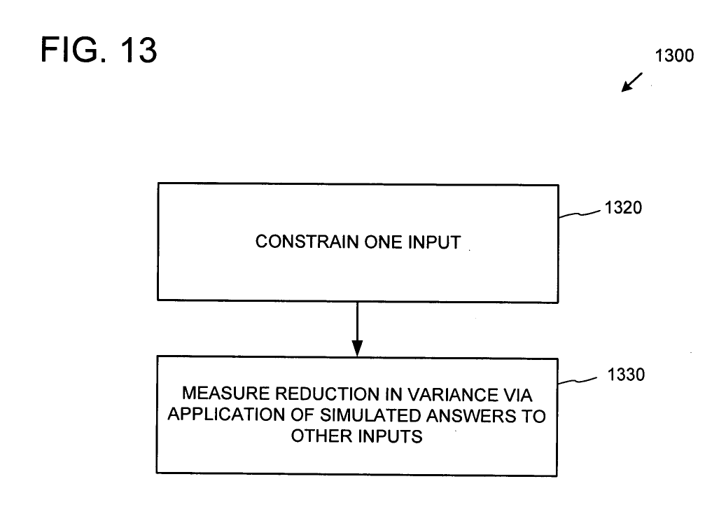

FIG. 13 is a flowchart of an exemplary method 1300 of determining expected reduction in variance if a question were to be administered, based on simulated answers and a constrained input. At 1320, one of the inputs is constrained. At 1330, as described herein, simulated answers can be applied to the other inputs (e.g., for which answers have not yet been collected) to measure reduction in variance expected if the answer were available for the constrained input.

In practice, the question for whichever answer that has not yet been given that has the greatest expected reduction in variance can then be presented to the candidate.

### Example 18

### Exemplary System Including a Trait Predictor

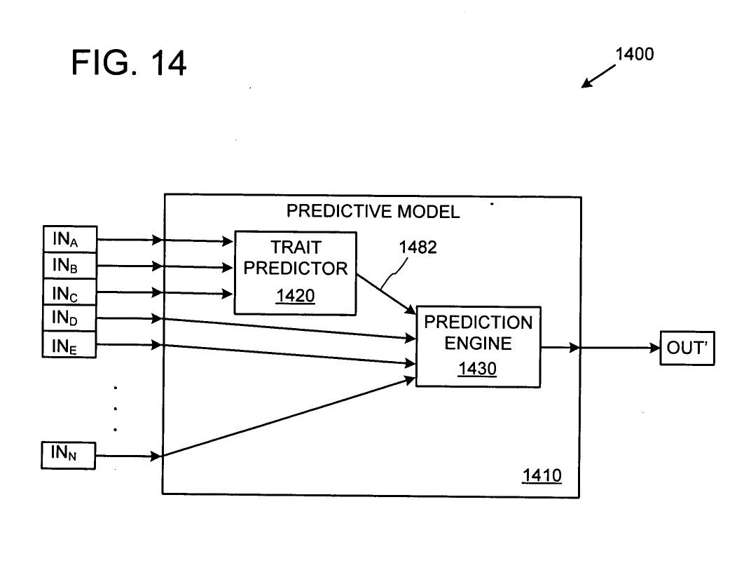

In any of the examples herein, a predictive model can comprise one or more trait predictors. FIG. 14 is a block diagram of an exemplary system 1400 including a predictive model 1410 employing a trait predictor 1420 to provide an output.

In the example, a predictive model 1410 includes a trait predictor 1420 that accepts some of the inputs directed to the predictive model 1410 and generates a trait predictor output 1482, which is fed to the prediction engine (e.g., a neural network) 1430, which then generates the output OUT′.

### Example 19

### Exemplary Method Employing a Trait Predictor

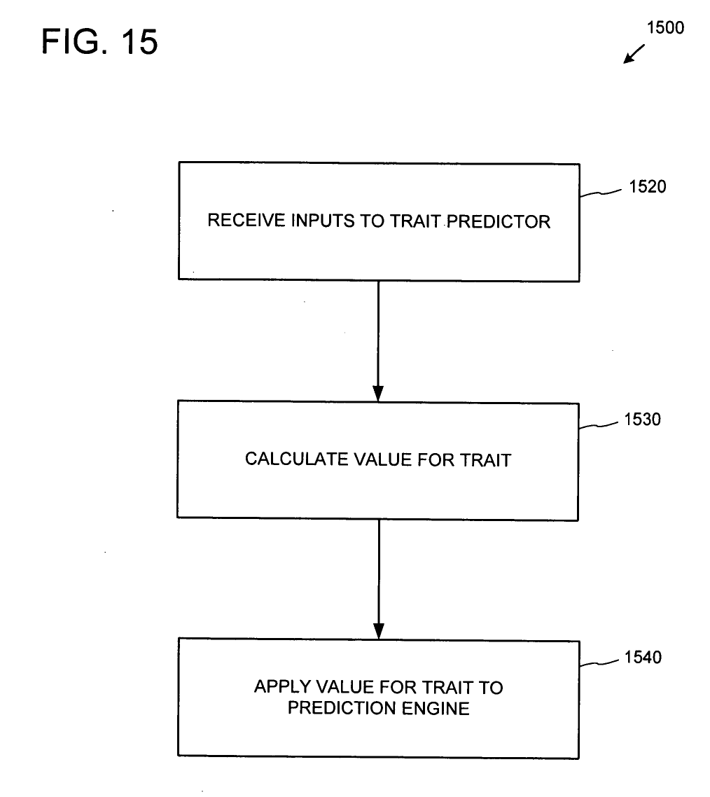

FIG. 15 is a flowchart of an exemplary method 1500 of employing a trait predictor.

At 1520, inputs to the trait predictor are received. At 1530, a value for the trait is calculated (e.g., via preprocessing). At 1540, the value for the trait is applied to the prediction engine to generate an output.

### Example 20

### Exemplary Trait Predictors

In any of the examples herein, a trait predictor can predict any of a variety of personality traits such as assertiveness, conscientiousness, diligence, integrity, responsibility, honesty, reliability, ambition, resilience, compliance, and the like. Trait predictors for other traits can be developed.

In any of the examples herein, a trait predictor can take the form of a scale, or a scale can be used in place of a trait predictor. The scale can group together a set of questions known to have correlation between their answers (e.g., knowing 4 out of 5 answers, the predictability of the 5^{th} answer is very high).

The trait predictor can apply pre-processing to its inputs to provide the output (e.g., to a predictive model), which can take the form of an estimate of where within a bell curve the candidate lies (e.g., a distribution from −3 to 3, with a standard deviation of 1). The output value is sometimes called \hat{θ} herein. Because such traits are often not determined explicitly, they are sometimes called “latent traits.”

### Example 21

### Exemplary System Choosing Between Questions

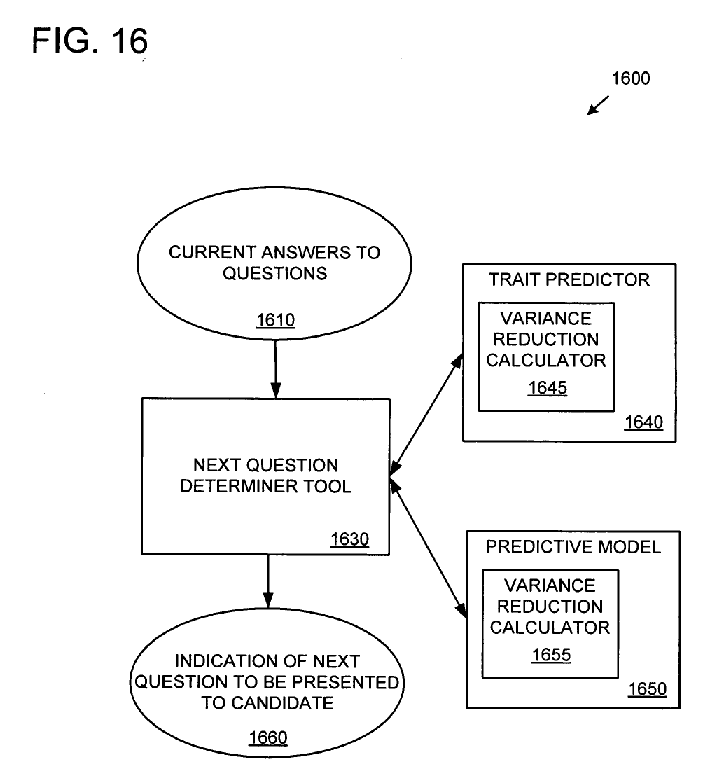

FIG. 16 is a block diagram of an exemplary system 1600 operable to choose between a next question from a trait predictor and a next non-trait predictor question. In the example, a next question can be picked, wherein at least one of the questions has an answer that is an input to a trait predictor 1640.

The next question determiner tool 1630 (e.g., a sequencer as described herein) can accept current answers to questions already provided by a candidate. The tool 1630 can consult a trait predictor 1640, which can determine expected reduction in variance if it had one more of its input answers via a variance reduction calculator 1645. Reduction in variance for a trait can be calculated by estimating of the reduction in error of measurement (e.g., as a variance) of the latent trait for items associated with the trait; the largest reduction can be multiplied by the neural network's sensitivity to the scale to calculate reduction in variance (e.g., of the predictive model 1650). The scale with the largest result is the best scale to apply an item from.

For questions that are non-trait predictor questions, a predictive model 1650 can be employed with a variance reduction calculator 1655 to determine the expected reduction in variance if an answer to one of the questions not yet presented were available.

Based on indications by the trait predictor 1640 and the predictive model 1650, an indication 1660 of the next question to be presented to the candidate can be output by the tool 1630.

As described herein, the tool 1630 can delegate determination of which question (e.g., out of the ones for the trait predictor 1640) is to be presented. The tool 1630 need not be informed of the question chosen.

In practice, functionality need not be arranged as shown. For example, the variance reduction calculator 1655 need not be an integral part of the predictive model 1650. Also, the variance reduction calculator 1645 can operate independently from the variance reduction calculator 1655.

### Example 22

### Exemplary Method of Choosing Between Questions

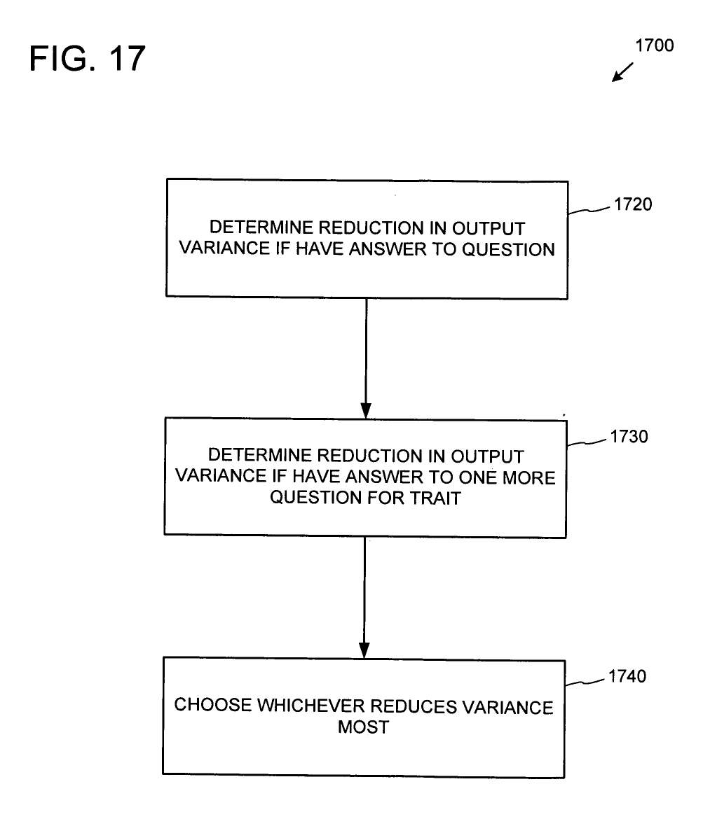

FIG. 17 is a flowchart of an exemplary method 1700 of choosing between a next question from a trait predictor and a next non-trait predictor question.

At 1720, expected reduction in output variance is determined if an answer by the candidate to a question (e.g., a non trait predictor question) were available. At 1730, expected reduction in output variance is determined if an answer to one more question for a trait predictor were available. At 1740, whichever reduces expected variance the most is chosen.

In practice, there can be one or more non-trait questions, and one or more trait predictors with one or more questions each. Whichever reduces expected variance the most can be chosen.

### Example 23

### Exemplary System Calculating Reduction in Variance

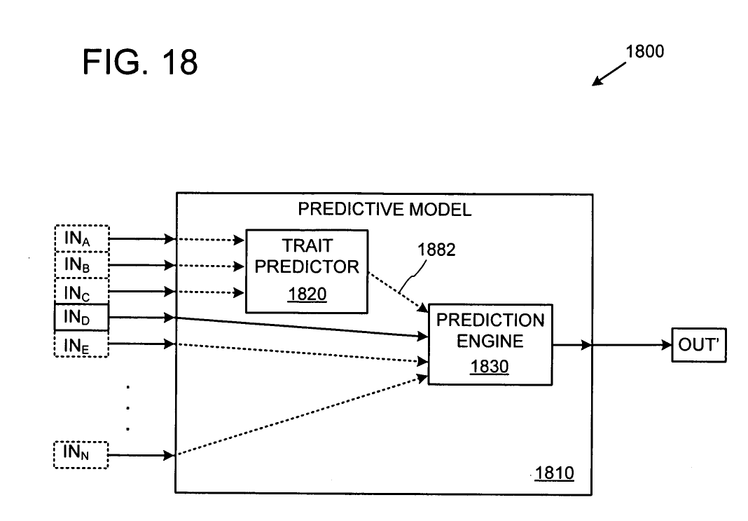

FIG. 18 is a block diagram of an exemplary system 1800 operable to calculate expected reduction in variance if a next question for a trait predictor were to be asked and answered in light of already having answers to one or more questions.

In the example, a trait predictor 1820 can output a trait value 1882 (e.g., if it has one or more input answers), which is used by a prediction engine 1830 to provide an overall output for the predictive model 1810.

The trait predictor 1882 can improve efficiency of processing by providing an expected reduction in the variance of its output 1882 if one more answer were available to the predictor 1882 without simulating answers. The resulting expected reduction in variance for the output OUT can then be calculated based on the expected reduction in the variance of the output 1882. In this way, simulated answers need not be applied to the inputs relating to the trait predictor 1882.

In some circumstances, the trait predictor 1820 may already have one or more answer already available to it. However, such an answer is not necessary. For example, one can use an informative prior distribution (e.g., one can assume that candidates are drawn from the same normally distributed population as previously observed candidates).

### Example 24

### Exemplary Method Calculating Reduction in Variance

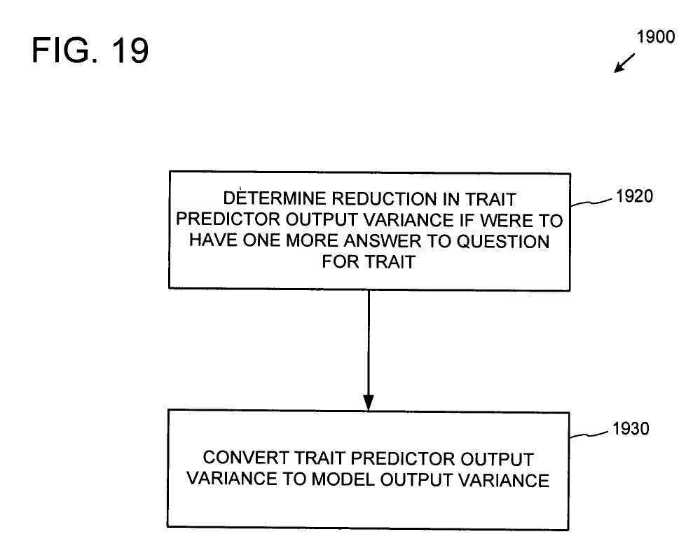

FIG. 19 is a flowchart of an exemplary method 1900 of determining expected reduction in variance if a next question for a trait predictor were to be asked and answered in light of already having answers to one or more questions.

At 1920, an expected reduction in the trait predictor variance can be determined if the trait predictor were to have one more answer for the trait predictor. At 1930, the expected reduction in trait predictor output variance can be converted to expected reduction in model output variance. The expected reduction in model output variance can be used to compare against other trait predictors or other questions for which expected reduction in output variance has been calculated.

In practice, when a trait predictor is then selected, it can indicate the next question out of its set of questions that can be asked and answered to result in the expected reduction in variance.

### Example 25

### Mathematical Efficiencies

Input items within a scale can be modeled mathematically. Techniques can be used to go directly from the probability of responding in a given way to an item (e.g., if a candidate possesses a given quantity of a trait, 0) to knowing how much information the item provides, to knowing which item is the best one to administer next and how much variance is expected to be reduced.

### Example 26

### Exemplary Overview of Technologies

A computer-administered system can collect pre-employment applicant information used to assess suitability for employment (e.g., in specific jobs). The system can implement a method of on-line (e.g., over the web via HTTP) item selection that optimally informs a neural network about the particular applicant for whom a suitability judgment is to be made (e.g., provided that the neural network is trained on several applicant attributes which can be measured prior to employment).

The system can perform adaptive or conditional information gathering. Following the measurement of each attribute, the system can use statistical estimation procedures to determine which measurement to make next (e.g., the most beneficial measurement). The system may be restricted to measuring only a limited number of attributes, in order to require less applicant or facility time, or to avoid fatigue. Because the most useful attributes can be measured first, the result can be a large reduction in the length of the assessment with perhaps a small reduction in the accuracy of the suitability judgment. Adaptive information gathering can result in a more efficient assessment than collecting information for all the attributes on which the neural network is trained.

### Example 27

### Exemplary Attributes

In any of the examples herein, an attribute can be any measurable quantity (e.g., answer to a question) for a candidate. Attributes can be collected online electronically for the candidate (e.g., as part of an assessment taken by the candidate).

### Example 28

### Exemplary Applicants

Although several of the examples describe an “applicant” or “candidate employee,” such persons need not be candidates at the time their data is collected. Or, the person may be a candidate employee for a different job than that for which they are ultimately chosen.

Candidate employees can come from outside an organization, from within the organization (e.g., already be employed), or both. For example, an employee who is considered for a promotion can be a candidate employee.

Candidate employees are sometimes called “applicants,” “job applicants,” “job candidates,” “examinees,” and the like.

### Example 29

### Exemplary Computer-Readable Media

In any of the examples described herein, computer-readable media can take any of a variety of forms for storing electronic (e.g., digital) data (e.g., RAM, ROM, magnetic disk, CD-ROM, DVD-ROM, and the like).

Any of the methods described herein can be implemented by a computer. For example, any of the methods described in any of the examples herein can be performed (e.g., entirely) by software via computer-executable instructions stored in one or more computer-readable media. Fully automatic (e.g., no human intervention) or semi-automatic (e.g., some human intervention) can be supported.

### Example 30

### Exemplary Items

In any of the examples herein, an item can include a question (e.g., multiple choice) or other stimulus presented to collect an input value for a predictive element. A candidate employee's response to an item (e.g., an entered response, latency in answering, or both) can be used as a direct or indirect input to a predictive model.

### Example 31

### Exemplary Predictive Models

In any of the examples herein, a predictive model can be a neural network, expert system, or other artificial intelligence model.

### Example 32

### Exemplary Predictive Power

In any of the examples herein, predictive power can be determined via sensitivity, expected reduction in variance, imputation of values (e.g., at random, filtered by a distribution, or both), and the like.

### Example 33

### Exemplary Technologies

Artificial intelligence technology can be used. Assessment of individual differences can be used in the field of employee selection to identify desirable candidates (e.g., who, among those candidates available, is more likely to succeed in a given job or in a given occupation). Individual differences may include personal traits, skills, knowledge, interests, beliefs, life history or background, physical capabilities, possession of legal documents, certifications, and other systematically measurable attributes.

An assessment to be used to inform a selection decision can be valid; that is, it is known to predict some part of job success, a criterion. Criteria can include performance ratings by managers, coworkers or customers, as well as “hard” productivity measures such as dollar sales per hour, transactions processed, units produced, length of service, completion of a training or probation period, promotions, disciplinary incidents, accident rates, and the like. The process of criterion validation can be used to prove the degree to which an assessment is valid with regard to a particular part of job success, and to provide or refine a mathematical model by which that assessment may be used to predict that criterion.

The degree of validity of an assessment used to predict a job outcome has a real value to the employer using the assessment. Four cases of a prediction and the actual subsequent outcome can be defined, as shown in Table 1: true positive and negative, and false positive and negative. A more valid assessment produces more true positive and negative predictions, and fewer false positive and negative predictions.

TABLE 1
Exemplary Classification Outcome Matrix

| | Outcome negative | Outcome positive |
|---|---|---|
| Prediction positive | Assessment incorrectly | Assessment correctly |
| | predicts good | predicts good |
| | performance: false | performance: true positive |
| | positive | |
| Prediction negative | Assessment correctly | Assessment incorrectly |
| | predicts poor | predicts poor |
| | performance: true | performance: false negative |
| | negative | |

Accuracy and reliability can go together, and tend to require more measurement time. However, measurement time results in real costs. Facility space and equipment time have financial value to their provider. In addition, effects of the assessment on the applicant (e.g., fatigue and irritation) can cause an otherwise acceptable potential employee to not finish applying. Measurement time can be balanced with accuracy to achieve an efficient assessment.

### Example 34

### Exemplary Adaptive Assessment

Adaptive assessment can include a methodology of testing or measuring human attributes. Adaptive assessment can include Computerized Adaptive Testing (CAT). In CAT, a computer can administer a variable sequence of test questions, one at a time, determining which questions will be asked later on the basis of the answers given earlier. Such a method can avoid asking redundant questions or questions which do not apply to the examinee, and therefore can administer a shorter test.

CAT can use the mathematics of Item Response Theory and measure a single latent trait, which is an unobservable but stable attribute of a person. This type of CAT can be used in such fields as certification and academic testing. In such a case, the method can avoid redundant and inapplicable questions by avoiding questions too easy or difficult for the examinee. It can begin by asking a question of medium difficulty and adjust toward hard or easy questions until it reaches a level where the examinee answers a certain number (e.g., about half) of the questions correctly.

In any of the examples herein, CAT can be used to predict a single future outcome, using multiple current attributes (e.g., incorporating artificial intelligence technologies).

### Example 35

### Exemplary Adaptive Assessment

In any of the examples herein, the adaptive question selection techniques can be used in a scenario involving generating a score (e.g., a predicted outcome) for use in a hiring decision using multiple current attributes.

### Example 36

### Exemplary Artificial Intelligence

Artificial Intelligence (“AI”) approaches include expert systems and neural networks.

Expert systems can reflect the knowledge of human experts. These systems can gather factual information and make sequential decisions, according to a system of predefined rules and logical branching. These systems can be programmed explicitly with the rules of human decision making in a particular context. Expert systems can be used to standardize complex procedures and solve problems with clearly defined decision rules.

Neural networks can go by a variety of names, including connectionist models and parallel distributed processors. Neural networks can take on a variety of specific forms. Neural networks can be composed of a hierarchy of modular calculating components, called nodes. They can learn from experience with examples and correction. The nodes can have a memory for examples which have been presented, which is condensed into a statistical model that can be applied to future experiences. Neural networks can represent models of complex nonlinear relationships, even when the source data is inconsistent, incomplete, or subject to errors.

The capacity to function with and compensate for noisy data makes neural networks useful to real world applications where expert systems are not appropriate. Neural networks can solve problems of classification, prediction, pattern completion, optimization, and mechanical control.

The technologies described herein can use neural network-based adaptive assessment. Such an approach can be implemented as a hybrid artificial intelligence application (e.g., an expert system can control and present information to a neural network, which then supplies the information needed by the expert system's decision rules).

A neural network can be integrated into adaptive assessment techniques. Although the examples involve prediction of human behavior in the workplace, the technologies can also be applied in other behavioral prediction domains. These techniques could equally well be employed in education, training or certification programs to evaluate broad competence; in medical, psychiatric or social services programs to evaluate the risk of a behavior or the likelihood of a condition; in credit or insurance evaluations of financial hazard; and in other disciplines that attempt to predict an individual's future behavior (e.g., on the basis of complex and varied current information).

### Example 37

### Exemplary System

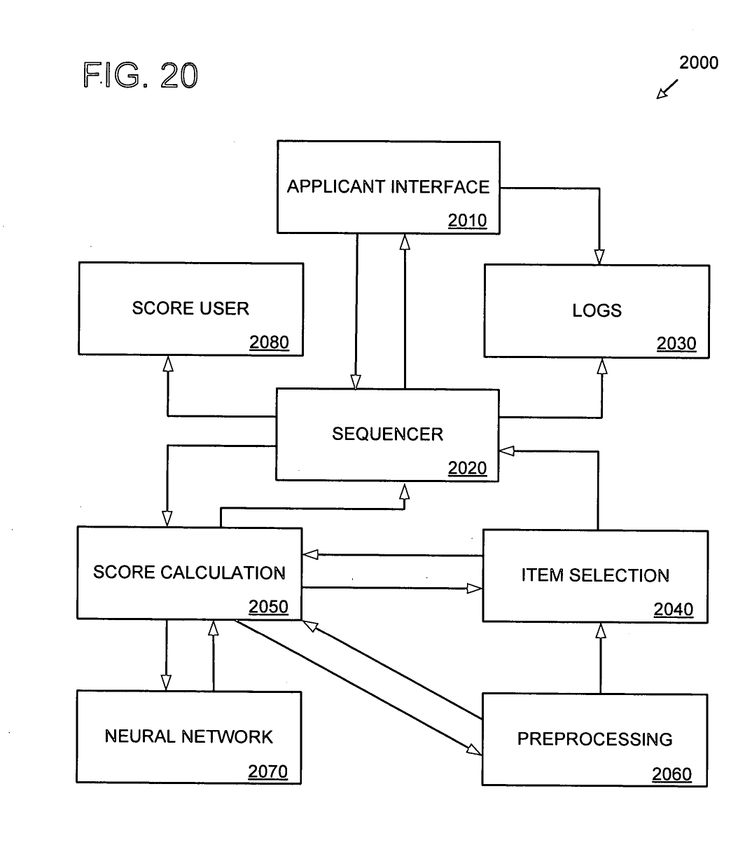

FIG. 20 shows an exemplary embodiment of a neural network adaptive assessment system 2000. In the example, the system 2000 includes an applicant interface subsystem 2010, a sequencer subsystem 2020, a logs subsystem 2030, an item selection subsystem 2040, a score calculation subsystem 2050, a preprocessing subsystem 2060, a neural network 2070, and a score user subsystem 2080. A description of each subsystem follows the reference numbers detailed in the system diagram.

### Example 38

### Exemplary Applicant Interface

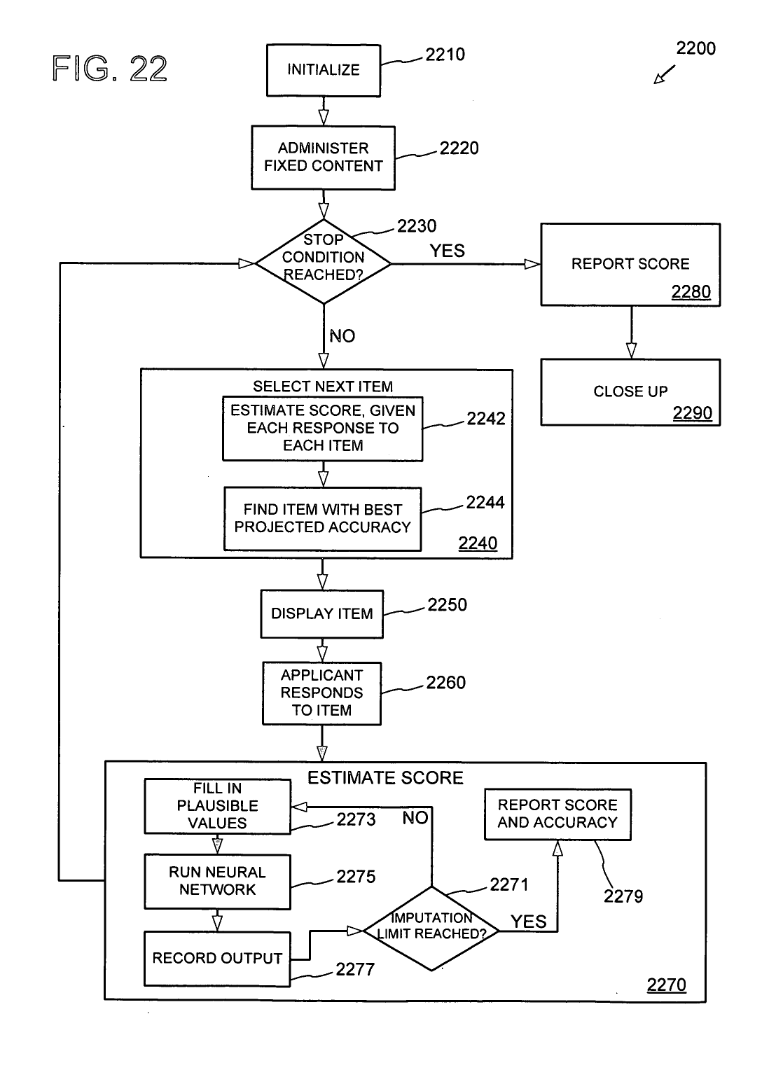

The applicant interface 2010 of FIG. 20 can present the assessment (e.g., assessment items, such as questions) and collect response data. The applicant interface can be a software component which displays information, such as on a computer monitor or over a telephone, and accepts input, such as with a keyboard, mouse, or microphone. This software may run on either the same computer which performs the computations of the Exemplary Sequencer (e.g., the computations detailed in the estimate score action 2270 of FIG. 22), or on a thin client that maintains a telecommunications link to a server which performs those computations.

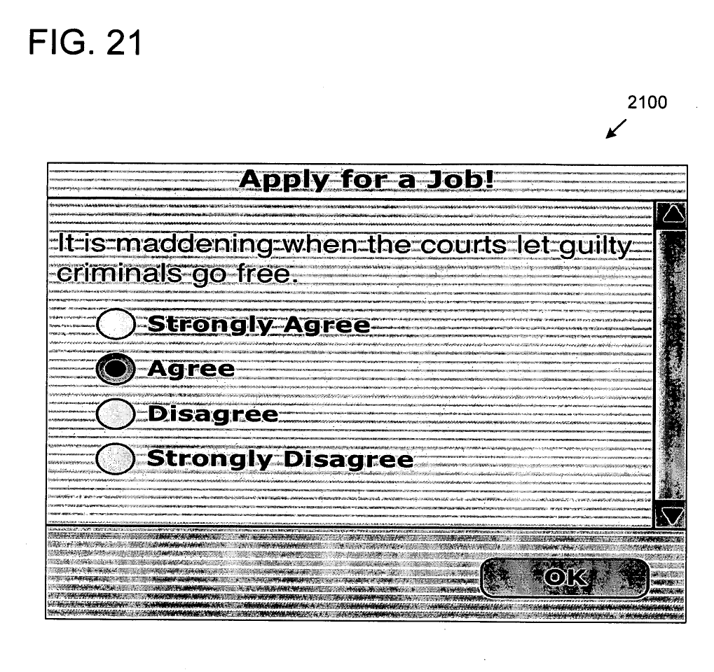

FIG. 21 shows an exemplary user interface 2100 that can be presented by the applicant interface subsystem 2010 of FIG. 20. In the example, the user can select from one out of a plurality of presented options, which is recorded as response data.

The applicant interface can allow the applicant to start and stop the test. While the test is running, the applicant interface can display attribute measurement stimuli (e.g., items such as questions), instructions, and information such as legal statements to the applicant, as instructed by the Sequencer. It can allow the applicant to respond to the items. The format of response for an item can include open-ended textual responses, choices between displayed options, and other formats. Upon completion of the items displayed at one time, the applicant interface returns responses given to the sequencer 2020. At that time it can also record the applicant's responses and response latencies to the logs subsystem 2030.

### Example 39

### Exemplary Sequencer

The sequencer can be a software component which determines when to invoke the initialization, normal termination, item selection 2040 and score calculation 2050 routines. The sequencer can keep a running count of items administered, keep track of the error of measurement, or both, according to the condition established for invoking normal termination. The sequencer can also send information out to the logs 2030 (e.g., the date and time started, the sequence number of the current item, the identifier and content of the item chosen, and the applicant's score).

FIG. 22 is a flowchart of an exemplary method 2200 for administering an assessment test and can be implemented, for example, by the sequencer 2020 of FIG. 20 in a neural network adaptive assessment system.

At 2210, initialization routines are carried out upon initiation of input by the applicant. For example, the applicant can start the test.

At 2220, any invariant content, such as instructions, legal statements, and requests for identifying information is administered (e.g., in fixed sequence). For example, the applicant interface 2010 can be instructed to administer such content. Responses are received (e.g., from the applicant interface 2010).

At 2230, if no stop condition is reached, the next item is selected at 2240 (e.g., via invoking an item selection routine 2040 of FIG. 20). For example, the next item can be selected by estimating the score which would result from each response to each item at 2242, and determining which score is associated with the lowest variance at 2244.

At 2250, the item to be administered is administered (e.g., displayed for consideration by the user). For example, the applicant interface 2010 can be instructed to administer the item or items selected.

At 2260, responses are received (e.g., from the applicant interface 2010). For example, the applicant can respond to a displayed item.

At 2270, a score can be calculated (e.g., by invoking the score calculation routine 2050). For example, plausible values can be filled in at 2273, the neural network (e.g., the neural network 2070) can be run, and output recorded at 2277. If the imputation limit has not yet been reached by a check at 2271, more processing can be done.

Otherwise, at 2279 the score and accuracy can be reported.

At 2230, achievement of the normal termination condition is tested 8. If it has not been achieved, processing can continue at 2240. Otherwise, processing can flow to 2280.

At 2280, the score can be transmitted (e.g., to the score reporting system 2080 of FIG. 20)

At 2290, if desired, additional content (e.g., unscored) can be administered (e.g., in a fixed sequence by the applicant interface 2010). For example, demographic items or a “thank you” message can be presented. The process can then end or otherwise prepare for the next applicant.

### Example 40

### Exemplary Logs

Any of the logs described herein (e.g., the logs 2030 of FIG. 20) can be a software component responsible for ensuring that data passed to it is stored in an organized, safe and secure way. This can involve writing to a file, a database, or another structure.

The logs can receive data including item identifiers, responses, latencies, and scores on an ongoing basis from the applicant interface and sequencer. In order to comply with possible court orders, the data can be recorded to avoid loss, even if the test is unceremoniously aborted, the power fails, or some other part of the program crashes.

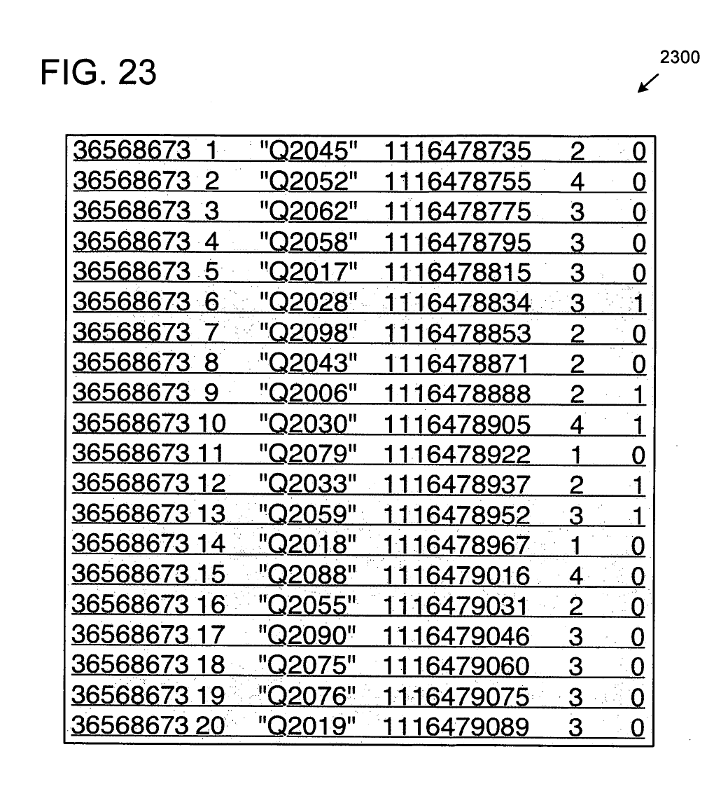

FIG. 23 shows an exemplary excerpt 2300 from a log for a neural network adaptive assessment system. In the example, an applicant identifier, a sequence number, an item identifier, and other information are shown.

### Example 41

### Exemplary Item Selector

In any of the examples described herein, the item selection routine (e.g., the item selection subsystem 2040 of FIG. 20) can compare the expected benefits of administering a remaining item (e.g., each remaining item) and indicate which item is to be presented (e.g., the item having the greatest expected benefit). The item selection routine can be a software component invoked by the sequencer 2020 and can communicate its findings to the sequencer 2020 which item is to be presented.

The item selection routine component need not maintain any data structures of its own from iteration to iteration. Given the responses which have been made to the invariant content and the items which have been administered, the item selection routine can calculate the expected benefits of administering the remaining items. The benefit it considers can be a measure of the precision of the final score as estimated (e.g., by in the score calculation routine 2050).

For remaining items which are not ordinarily entered into a pre-processing routine before score calculation, the item selection routine can provide multiple hypothetical responses and aggregate the score precisions. For example, multiple hypothetical responses can be provided in multiple invocations of the score calculation routine 2050, and reported score precisions can be aggregated.

For pre-processing routines such as conditional scoring or latent trait estimation prior to score calculation, the item selection routine can determine which item will lead to the best precision of the pre-processing score estimate. This may be done by a simplified calculation. The item selection routine can then translate the precision of the pre-processing score estimate to the precision of the final score by use of a sensitivity function (e.g., of the neural network 2070).

The resulting values of score precision can be compared, and the identifier of the item associated with the best value can selected for presentation (e.g., by communicating the identifier to the sequencer 2020).

### Example 42

### Exemplary Score Calculator

In any of the examples herein, a score calculation routine (e.g., the score calculation routine 2050) can provide a score and a precision measure (e.g., error of measurement). The prediction can be made for the current state of known responses or a hypothetical set of responses. For example, a sequencer (e.g., the sequencer 2020) expects the prediction made for the current state of known responses, while the item selection routine (e.g., the item selection routine 2040) asks about a hypothetical set of responses. Thus, the score calculation routine can be a software component that can be invoked either by the sequencer or by the item selection routine. In these two cases, it can behave essentially the same, but for different purposes.

The score calculation routine component can maintain a list of what response has been given to respective items, and the current best prediction with error of measurement.

The score calculation routine can also retain any other information for the neural network (e.g., the neural network 2070), such as any predictive information which may be opportunistically gleaned from associated content.

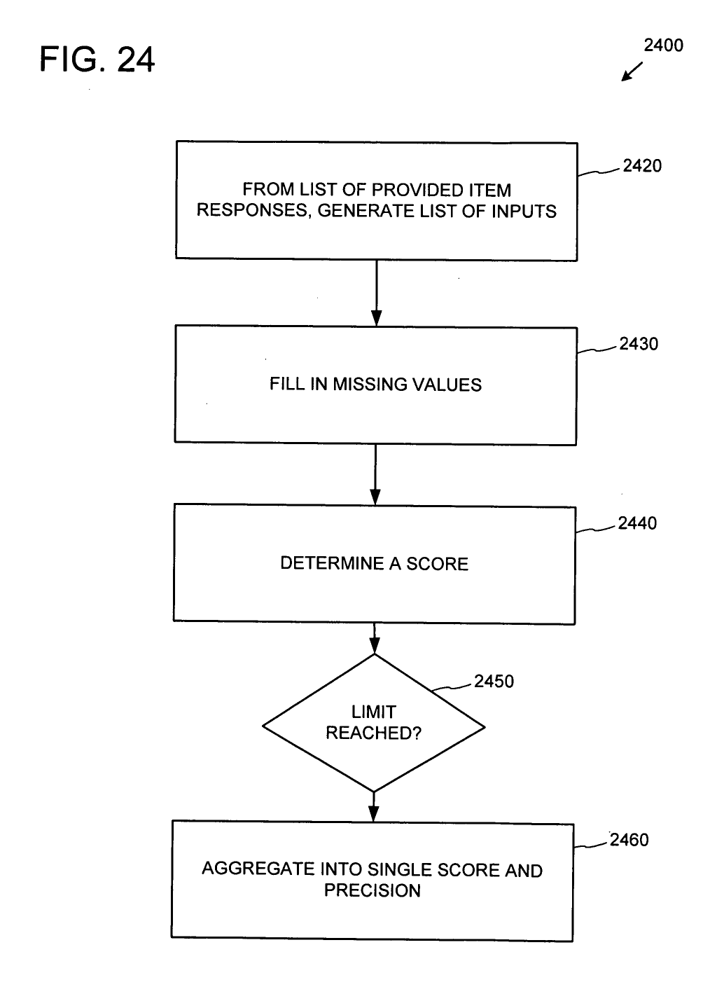

FIG. 24 is a flowchart of an exemplary method 2400 for calculating score in a neural network adaptive assessment system. For example, such a method 2400 can be performed when a new response is received (e.g., by the sequencer).

Before performing the method, the list of item responses can be updated (e.g., to include a newly received response). Or, a copy can be created for a hypothetical response. The list of responses can then be provided to the method.

At 2420, a list of inputs is generated from the list of provided item responses. The inputs can be of a format suitable for submission to a neural network (e.g., the neural network 2070).

At 2430, missing values (e.g., responses to items not yet administered) can be filled in. For example, the method of multiple imputations can be used as follows: generate random admissible values according to their likelihood (e.g., based on a distribution of collected responses). If some items require preprocessing, invoke an appropriate preprocessing routine (e.g., preprocessing 2060) to generate random admissible values for the result of preprocessing, according to the likelihood of those values; omit those items from missing value calculation (e.g., random values for such items do not need to be generated individually upstream from the preprocessor).

At 2440, a score can be determine for the completed list of inputs. For example, the neural network (e.g., the neural network 2070) can be invoked with the completed list of inputs. The resulting score can be recorded in a temporary list.

At 2450, it is determined whether the temporary list has reached a threshold number of entries. If not, processing can repeat at 2420 (e.g., with a different set of random values).

Otherwise, at 2460, the scores (e.g., in the temporary list) are aggregated into a single score and precision by statistical methods.

The score and precision can then be reported (e.g., to the sequencer 2020 or the item selection routine 2040).

### Example 43

### Exemplary Score Preprocessor

In any of the examples herein a preprocessing routine (e.g., the preprocessing subsystem 2060) can include software components that aggregate several item responses into a single value. The preprocessing routine need not be present, and if it is present, it can take a variety of forms. It can include expert systems designed to intelligently join the responses to conditionally related items and estimates of latent psychological traits based on the responses to several items with similar content.

The preprocessing routine can generate a score which can be used as a neural network input. Also, a statistical distribution of probable scores can be generated, even when the routine has only partial information, provided the acquisition of information is sequential. This may be accomplished through the technique of multiple imputations (e.g., as described above) or through another technique. Techniques which make use only of simultaneously-acquired data, such as a single item response and its latency (e.g., time from display to applicant response), need not contain a mechanism for generating a score based on partial information, as partial information is not expected to occur.

The preprocessing routine in the neural network adaptive assessment system can accept a list of responses to items which have been administered and, based on that list, generate a plausible value according to the statistical distribution of probable scores.

### Example 44

### Exemplary Neural Network

In any of the examples described herein, a neural network (e.g., the neural network 2070) can be a software implementation of a statistical model that consists of nodes (e.g., variables) linked by weights (e.g., coefficients). Before insertion in the adaptive assessment framework, it can be trained to predict a measurable outcome based on several predictor variables. Within the adaptive assessment framework, it can take a standard list of inputs on which it has been trained and return a score.

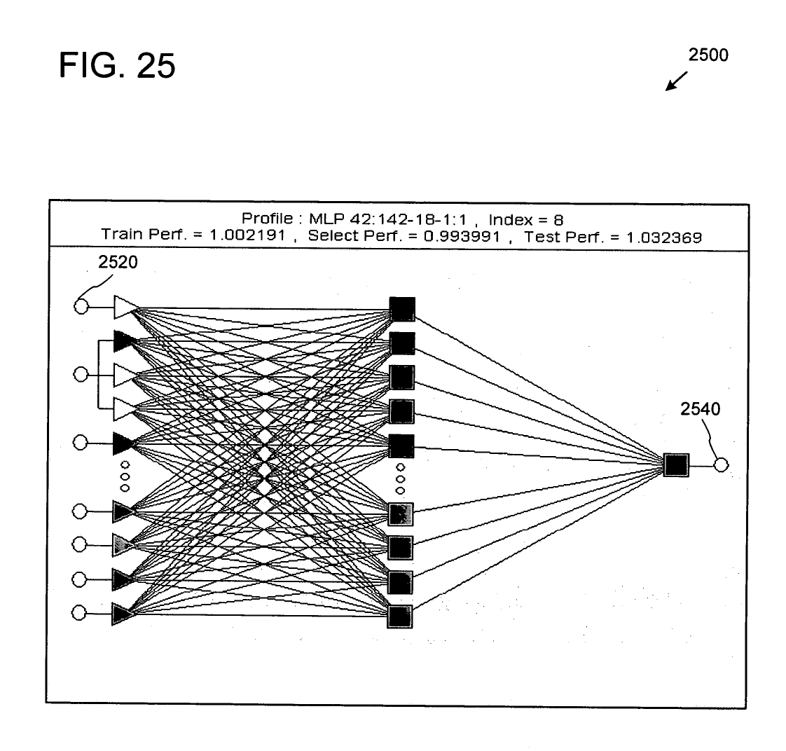

FIG. 25 is a block diagram of an exemplary neural network 2500. The neural network 2500 includes a plurality of input nodes (e.g., the input node 2520) and an output node (e.g., the output node 2540). In practice, the neural network 2500 can have a different number of input nodes, layers, or both.

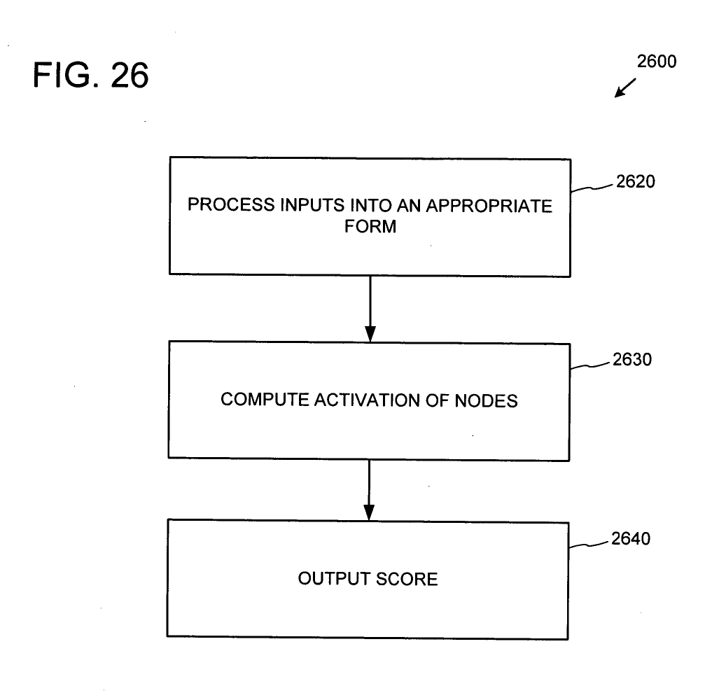

FIG. 26 shows a method 2600 for employing a neural network to calculate a score. At 2620, inputs are processed into an appropriate form. An example of this is the division of responses which may be any of a list of possibilities into several binary variables, the variables representing a respective category.

At 2630, the activation of nodes in the neural network are calculated based on the inputs. For example, activation of each node in the neural network can be computed one layer at a time.

At 2640, the score is output. For example, the value of the output node can be read and communicated back to the score calculation routine.

### Example 45

### Exemplary Score Reporter

In any of the examples herein, when the normal termination condition has been satisfied and a final score calculated, the score reporting system can record the score can be recorded (e.g., by a score reporter 2080) in a centralized, secure storage device, and the score can be made available to one or more users. The storage device may be a database on a central server. The score can be recorded a permanent digital or analog record such as an optical disk or paper. The users can include the applicant, a recruiter, a hiring manager, a scientific researcher during development or maintenance periods, a court of law, or anyone else permitted reasonable and legal access to the test score. The specifics of the score reporting system will vary accordingly.

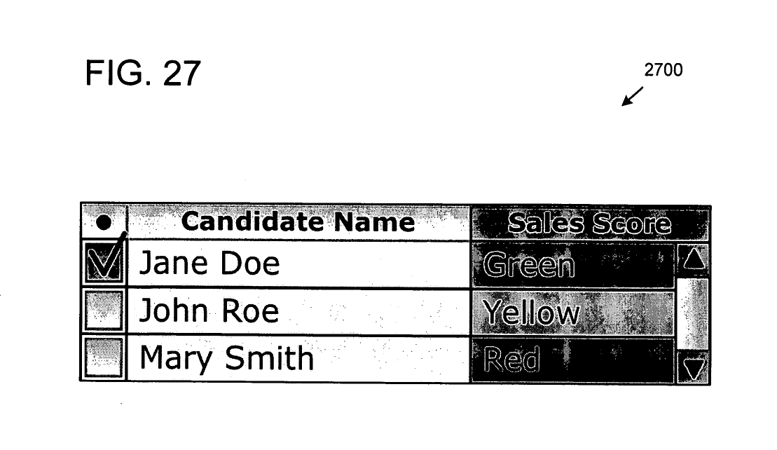

In some cases, the score can be scaled within two or more categories (e.g., poor, fair, good, green, yellow, red, or the like). FIG. 27 shows an exemplary screen shot 2700 of a user interface that includes the candidates names and a score (e.g., for sales). In the example, a particular candidate Jane Doe has been selected for further processing (e.g., a candidate interview or acceptance letter).

### Example 46

### Exemplary Process

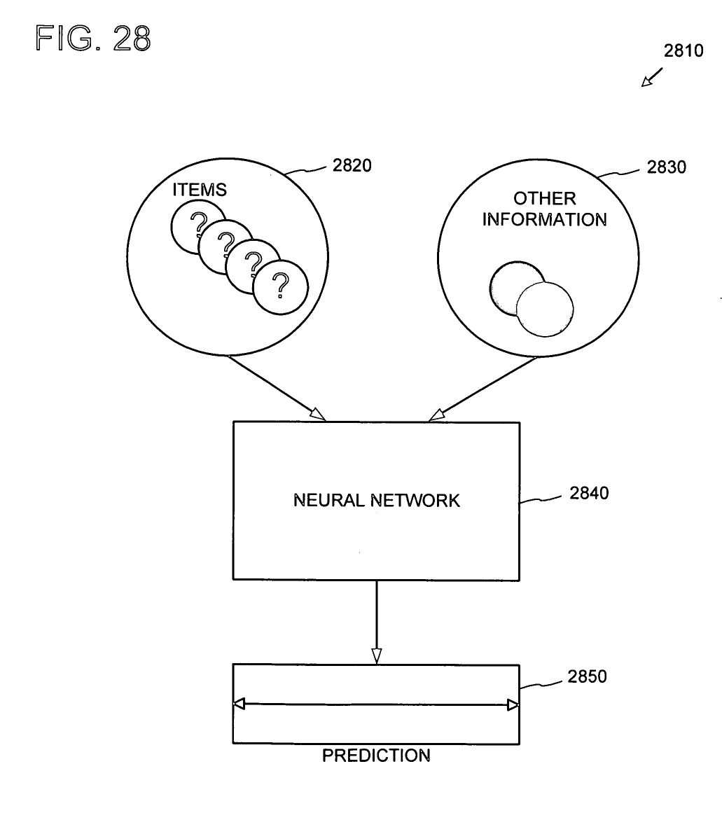

The accuracy of future job performance prediction can improve with each successive item response received. An item can be chosen to maximize this improvement. This process is illustrated in FIGS. 28-30.

Before the First Item

FIG. 28 shows a scenario in which the system 2800 makes a prediction before any adaptive items are administered. The information available to the neural network 2840 includes no administered items 2820, but some other information 2830 (e.g., biodata items). The information available indicates little diversity of applicant experience, and the prediction 2850 by the neural network 2840 has a very broad range. Thus, the score is not very helpful.

The first time the item selection and administration cycle is initiated (e.g., action 2240 in FIG. 22), the system 2800 knows little or nothing that it can use about the applicant. It begins by assuming that the applicant is, in general, like other applicants (e.g., all other applicants) on whom it was trained. It establishes a statistical description of the likelihood of each possible response to each item, and by imputation makes a highly uncertain prediction of the applicant's job outcome if hired.

The First Item

The system selects the item which it projects will make the greatest improvement to the accuracy of the outcome prediction. It presents the item and waits for a response from the applicant. When the applicant responds, the system updates its knowledge of the applicant's attributes and probable job outcomes. The accuracy of the job outcome prediction improves slightly.

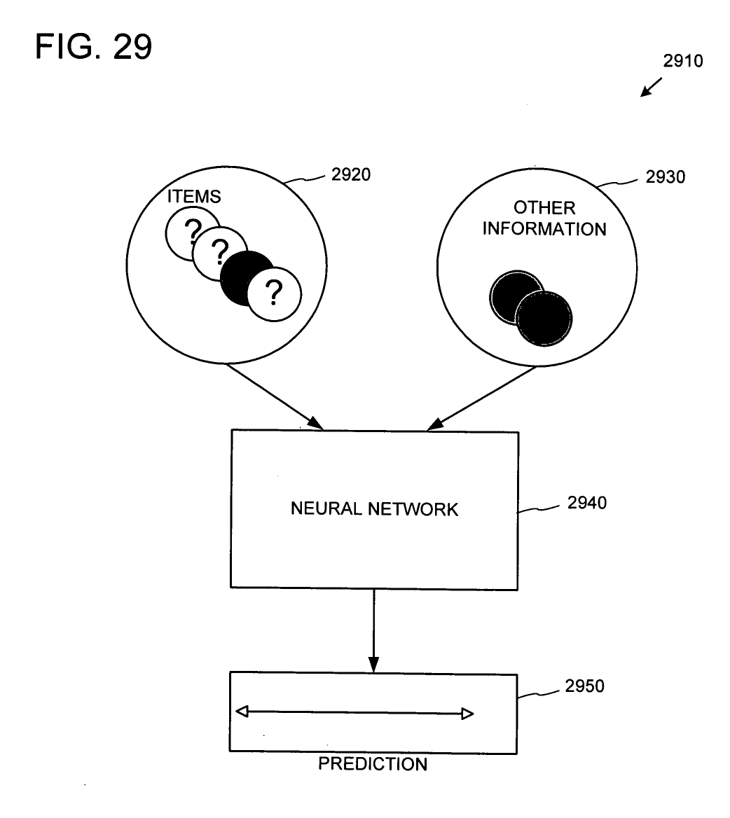

FIG. 29 shows a scenario in which the system 2900 makes a prediction after one item has been administered. So, there is now an answer to one of the items 2920. The system 2900 makes a better prediction after the first item. Different applicants receive different items, so the diversity of applicant experience indicated by the information (e.g., the items 2920 and the other information 2930) available to the neural network 2940 is greater. Thus, the range of the prediction 2950 can be smaller.

Successive Items

With each cycle, the system updates its information and chooses the best remaining item to administer next. Different applicants receive different sequences of items. On average, each item chosen is the one that accumulates useful information about a particular applicant most quickly, to zero in on the applicant's actual future performance.

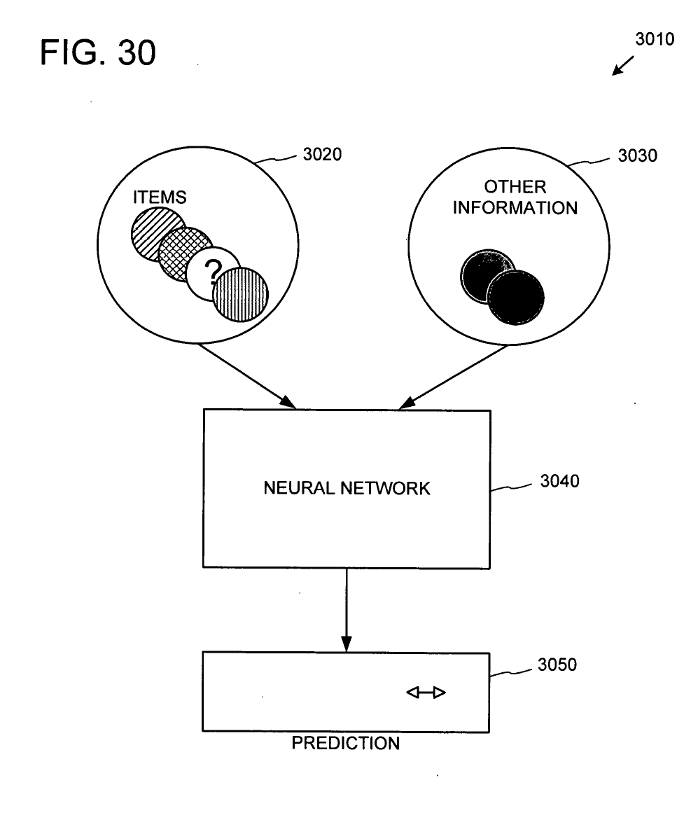

FIG. 30 shows a scenario in which the system 3000 makes a prediction after plural items have been administered. So, there are applicant-provided answers to plural of the items 3020. The system 3000 improves its prediction with each item. Different applicants can be presented with many different possible sequences of items (e.g., based on responses to earlier items).

Basing its prediction on the responses to items 3020 and other information 3030, the neural network 3040 can provide a prediction 3050 having a small enough range to be used as a basis for a hiring decision.

### Example 47

### Exemplary Feature

Adaptive input selection for a predictive model (e.g., neural network). In any of the examples herein, the system can deliberately choose which data will be present and which will be missing. All input data need not be present, and missing data is not necessarily missing because it is unavailable (e.g., because a candidate refuses to answer a question). Instead, the data can be missing because the system does not present the question (e.g., it chooses another question to present).

### Example 48

### Exemplary Feature

Multiple imputations of missing predictive model (e.g. neural network) inputs to estimate output uncertainty. In any of the examples described herein, repeated imputation of missing values can be used to estimate the effect of those missing inputs on the stability of the output value. Therefore the technology can have a measure of the accuracy of a specific prediction that is related to the quality of the input data.

The predictive model need not use a missing data code to represent missing data as a valid, separate, and meaningful possibility. A default value need not be used for missing input. And, a single random value need not be used for missing inputs. Instead, plural sets of inputs can be used to produce plural predictions.

### Example 49

### Exemplary Feature

Simultaneous Adaptive Testing of Several Potentially Unrelated Attributes.

In any of the examples herein, several attributes can be measured at once. The measurement of one attribute can contribute to the estimation of another. The measurement of one attribute can determine the priority of measuring another. Thus, flexible prioritization of attribute measurement can be implemented in a computer-based adaptive assessment.

The system need not measure only a single attribute or sequentially measure multiple attributes, such as in an interleaved fashion.

### Example 50

### Exemplary Information

When hiring a new employee (e.g., when several candidates are available), it is preferable to get the best available candidate, or at least, to avoid the worst. The time and effort spent evaluating candidates have real costs to a business, and hiring the wrong person may lead to firing that person and starting the process over. The wrong candidate may also steal from the business, be unsafe and risk injury for which the business is liable, or expose the business to costly lawsuits.

A brief assessment related to the job can be a way of selecting an above-average candidate more than half of the time. Computers can make assessments even more efficient. With the automation of the job application, an extra data entry step can be removed from the process. At the same time as it records applicant data, the computer can score the assessment, and evaluate the candidate according to strict rules. Network transmission permits centralized storage and continuous or routine monitoring of applications submitted at many locations. This process has a number of beneficial side effects, from reduction of paperwork to reduction of discrimination.

Any valid assessment can improve the quality of the hiring decision over none, including procedures such as interviews that we may not think of as assessments, but also more formal tests. Technological sophistication may improve the quality of the assessment, an improvement which is passed along to the hiring decision. Different technologies address different problems, but may be difficult to use in conjunction with each other. A neural network can be a general statistical model of the predictive relationship between assessment and outcome, which allows for nonlinear interactions between measures within a broad assessment. Adaptive item section can make a test more efficient while minimizing loss of information. The goals of the two methods are not incompatible, and the two techniques can be used together.

Technologies can adaptively select items to be used as inputs for a predictive neural net. The available data can be assumed to be multidimensional, nonlinearly interacting, and variable in utility. There can be a real cost in time and money associated with gathering each piece of information. The technologies can be modular; any of several components can be replaced with a different mathematical technique. Instead of strongly integrating scoring and item selection, technologies can be easily adapted to alternative measurement models. By combining adaptive testing methods with neural networks, a technology for testing can be more flexible, powerful and efficient than other techniques.

### Example 51

### Exemplary Employment Testing

Employees differ. There are qualities of the employee, as well as of the work and the work environment, that lead to different outcomes after hire, such as productivity, positive behaviors, off-task behaviors, workplace theft and even violence. Predictive methods can anticipate one or more of these outcomes in an applicant before hiring, so that a negative outcome may be avoided or a positive outcome achieved.

Various attempts to predict employee behaviors can focus on predicting at least two components: competence to do the job, and inclination to do the job. Performance measures may be separated into measures of maximal performance, under which the employee is particularly motivated for the testing period, and typical performance, which reflects both ability and inclination under ordinary conditions. Which type of performance is important may depend on particular job conditions. For example, a cash register operator can be slow most of the time and still be considered a good employee, if he picks up the pace to keep up with busy times. Estimating both types of performance, however, calls for knowledge of both the employee's ability and personality. An assessment may predict one or the other, or both.

An assessment may include questions for obtaining any of the biodata described herein. A pre-employment assessment can also include a skills test, which has close cousins in the knowledge test and the work sample. This group of tests involves direct measurement of the applicant's preparation to do the job. A work sample, for instance, is a rated performance of a selection of job tasks. While the applicant may be more motivated than the hired employee, a demonstration of skill or knowledge still predicts best performance. Predictive validities for work samples and for job-related knowledge tests are typically much higher than the validity of number of years of experience alone.

Skills tests and work samples are not applicable to untrained or inexperienced workers, nor are they good for “unskilled” jobs, where most of the population possesses the necessary skills or can easily learn them. They are most appropriate to skilled crafts such as carpentry, butchery, welding, and mechanical repair. Similarly, knowledge tests are typically only applicable when the applicant has had training, education or experience which is pertinent to the job and not near-universal.

A second class of test is the ability or aptitude test. These tests can be used with applicants who are expected to be trained in job-specific skills after they are hired. While there are many possible ability tests, including ones to measure physical characteristics such as visual acuity or strength, the most common ability tests measure either general or specific mental abilities.

General mental ability tests can predict how fast and how well an employee learns a job. Validity varies depending on the complexity of the job. Tests of general mental ability can be the most valid and least costly of the broadly applicable selection procedures. The more complex the job, the higher the validity. Over the long term, general mental ability was more important than years of experience, and correlated with skills tests and work samples.

Tests of specific mental abilities, such as spatial ability, memory, and reasoning, are also used in practice. These tests typically load heavily on a general ability factor, but can contribute some unique variance.

In low-complexity jobs, where competence to do the job can generally be assumed, the relative value of inclination to do the job increases. Motivation may come from both internal and external influences. Some influences are stable, including expectations of consequences, perceived norms, interests, and personality traits. Others are affected by day to day conditions and may be difficult to predict.

The measurement of personality traits in a work context can be done. The set of personality traits that are relevant to job performance is distinct from the set of traits which together fully describe a person. Although many researchers are familiar with small sets of broad personality traits which characterize individual differences in a general sense, such as the Big Five, these factors are sometimes considered to be the top level of a hierarchical model. A broad factor such as Conscientiousness, when closely studied, encompasses related but distinguishable components such as achievement orientation and diligence. More than one level of that hierarchy can be of use in the context of employment testing.

Tests of conscientiousness, in its Big Five form, can be useful for selecting employees. Conscientiousness has a direct, rather than moderated, relationship with job performance, and may predict integrity, responsibility, honesty and reliability, which are components of inclination to do a job. Specific integrity tests can be used to reduce the likelihood of counterproductive behavior on the job, and may have a higher correlation with performance than broad conscientiousness tests. Not all integrity tests are equal. They may be overt or covert, the latter being closer to tests of the conscientiousness trait.

Some personality attributes can be useful for selecting employees for particular classes of jobs, but not all jobs. Managers and salespeople both have jobs that call for interaction with new people on a regular basis, an aspect of the job which is either not present or not prominent in many other professions. For these professions, extraversion can be predictive. Extraversion has components of sociability and ambition, but also tends to reflect general activity level, any of which might be expected to influence performance on some jobs. Several extraversion-related constructs have effects, including assertiveness and the expectation that one can influence others, on the performance of employees making sales calls. An effect of emotional resilience can also be found. Or, there may be no effect of emotional stability.

It may be inferred that “job performance” need not be a trait or behavior, but can rather be a composite of behaviors influenced by a potpourri of traits. While ability measures may have positive manifold, personality measures are not necessarily correlated with each other or with ability. The predictions to be made are further complicated. Job tenure is not, strictly speaking, a performance measure. Tenure may be defined by performance, in that unsatisfactory performers may be fired, but it may also be limited by the employee's comfort with the work and environment. Comfort may or may not be related to performance. There are also more general issues concerning criterion measures, which set the stage for the use of sophisticated statistical models such as neural networks.

Measures can be validated based on theories. Because of the time scale and stakes involved, experimental manipulations are limited; laboratory conditions generally can not adequately approximate a long-term job environment. Although some manipulations are possible (such as selection based on a test, or assignment to different training or working conditions), most validity studies linking a psychological trait to an occupational outcome are correlational. Causality is commonly assumed from temporal order, but strong evidence for causation is rare.

Correlational data are subject to uncontrolled variance. Statistical techniques may be used to correct for apparent sources, but not all sources are apparent. These conditions present challenges for modeling, not the least of which is that the presence of noise on at least the order of the effect size can obscure the effect in any visual evaluation.

Large-scale warehousing of business data is feasible. This facilitates data-mining operations in numerous fields of study, in which data collected for the purpose of business are sifted through for theoretically interesting relationships.

Marketing research, for example, may compare purchasing profiles of different demographic groups, or link the frequency of one type of purchase to the frequency of another. Datasets of this type may have cases in the millions, if one case is a person.

The practical utility of a relationship may, for example, lead to the acceptance of an ad hoc theory. On the other hand, by the nature of exploratory analysis, relationships may be discovered which were not expected, or which were too subtle to detect in smaller traditional studies. Confirmatory studies, such as determining the predictive validity of an assessment, also benefit from the larger sample sizes.

Managers' evaluations of employees are subject to the influences of irrelevant factors (e.g. personality factors on an ability judgment), halo effects, leniency, severity, and central tendency. There may be implied incentives in place for good reports. On the other hand, the average incumbent employee is probably better than the average candidate, and so their scores may be lowered by comparison with available examples. Empirical performance records such as cash register speed or sales volume may be compromised by low compliance, as well as effects of time of day, season, and co-worker performance. Even hire and termination records may be incomplete or inaccurate due to manager noncompliance (with corporate rules, in this case) or administrative delays.

Restriction of range is a further problem which is not corrected by sheer sample size. If a valid test is used for selection, its apparent correlation with criteria measured only on the selected population will drop. There are statistical corrections for this effect, but they are dependent on several assumptions which are often violated in practice, and others which are difficult to check. When possible, it is best to “try out” a test on an applicant population and validate it before it is used to select anyone; on the other hand, even this procedure is compromised if any selection process is in use which correlates with the outcome of the test. A different test may be such a process, but so may the informal judgment made by a hiring manager. Because the uncorrected validity coefficients are conservative, they may be considered a minimum for realized validity.

It may be considered a benefit of large-scale automated standardized assessment that it is easy to detect subtle effects of applicant characteristics. For example, thousands of cases give plenty of power to test for discrimination against protected groups, or even differential item or test functioning. Regional differences are apparent; even site-to-site differences within a city are relevant. However, the proliferation of such findings is also an indication of overall data quality. Unless given meaning in terms of psychological constructs, these incidental findings obscure the relationship between assessment score and outcome.

Efforts to reduce extraneous, measurement-induced variation in the predictor or criterion data will not make the model fit well if the test is based on the wrong psychological model. Researchers always run the risk of this, but have compounded the problem by putting all the eggs in one basket. Overwhelmingly, researchers relating personality to occupational performance have tested linear models. The reasons for selecting a linear model include simplicity, comprehensibility, ease of computation and relatively low sample size requirements. A linear model can be easily translated into a test scoring algorithm, possibly involving weighted sections. Some psychological theories specify a linear or proportional relationship for stronger reasons, but others do not. In order to account for more of the variation among employees, it may be necessary to adopt nonlinear statistical models and more complex modes of scoring tests.

### Example 52

### Exemplary Biodata

A common class of pre-employment assessment is not what an applicant might think of as a test at all. A fair amount of biographical information can be gathered about a job applicant for administrative purposes, and this “biodata” may be used opportunistically to predict success or misbehavior on the job. Biodata may include identifying information, demographic information, information about the applicant's employment history, information about education or credentials, or information about conditions such as veteran status.

Biodata may be used to screen applicants quickly for minimum qualifications, such as possession of necessary documents or being old enough to legally work. It may be disregarded for legal or ethical reasons, such as to avoid unfair discrimination against groups, but retained in order to track company demographics, to receive tax credits, or simply to pay the employee. Finally, biodata may be useful in assessing an applicant's competence to do a job, through credentials or job history, and an applicant's behavioral tendencies, also through employment history. Having held a series of related jobs may be a good sign, but getting fired from each one is probably not.

In a meta-analysis across numerous samples and several specific criterion measures, biodata may have validity in predicting job performance, and lower validities for job experience, educational level, and a measure of training and experience. It is difficult to accept such a value without further qualification, as the utility of biodata no doubt reflects the choice of biodata. Biodata may act as surrogates for constructs such as general mental ability or ambition, which may be measured more specifically.

In practice, some biodata can be collected during the process of application, in order to be passed on to the hiring manager or payroll office, and it may or may not be opportunistically used.

Exemplary biodata items include questions about contact information, questions about school (e.g., “Are you currently in school?”), questions about former employment (e.g., “May we contact your last employer?”), familiarity with the employer (e.g., “Have you ever shopped here?”), and job goals (e.g., “Are you looking for a full time or part time job?”).

### Example 53

### Exemplary Assessment Format

In any of the examples herein, an assessment can be presented to a candidate employee in a format so that biodata items (e.g., questions) are presented first and the test portion (e.g., a plurality of questions that are presented to the candidate employee based on the adaptive techniques described herein) of the assessment follows. Biodata items can be fixed or adaptive techniques can be applied to them. However, in some cases (e.g., for legal reasons), certain items can be designated as mandatory. A question that appears to be a biodata item can be included as a test item if desired so that it is presented in the test portion of the assessment.

### Example 54

### Exemplary Neural Networks

One type of technology that can be used is the artificial neural network. Neural networks can perform distributed computations across numerous nodes. Neural networks can be used as a general statistical model to predict an outcome or set of outcomes from a set of inputs.

Artificial neural networks are computationally intensive, but typically well within the capacity of cheap modern computers. They are also adaptable to a wider range of actual functional relationships between independent and dependent variables than classical statistical techniques in the industrial psychologist's toolkit, such as linear multiple regression. They are able to systematically “learn” directly from data in the absence of extensive human interpretation. They do not require, for example, that the salient interaction effects be pointed out to them beforehand.

Usable in their capacity to model statistical patterns, artificial neural networks (henceforth “neural networks”) can be of use to industrial psychology.

Neural networks in industrial and organizational psychology can operate in at least two modes: classification and prediction. The can also be used for pattern completion, control, and constraint satisfaction.

Classification is of use for some organizational applications. For example, a self-organizing map can categorize employees in a hospital setting into four groups based on measures of organizational commitment. Follow-ups showed different patterns of behavior between these groups, but the modeling took place prior to measurement of the outcome variables and was descriptive in nature. Such exploratory contexts are ideal for clustering and classification techniques.

A neural network operating in this mode may predict either continuous or discrete variables. The latter form may also be called classification, in the sense that the neural net is learning an existing categorization, but this is not to be confused with the classification methods described above. Unlike those methods, the neural network does not invent a classification according to the structure of the inputs, but rather attempts to describe the structure of the outputs in terms of the inputs.

In this context, alternatives to neural networks include discriminant analysis and linear regression. Both of these techniques can be defined as neural nets on which restrictions have been imposed, special cases, but they have advantages related to their simplicity. They have been extensively studied and are well known. Their parameters are computed explicitly in a single step using linear algebra. Both the models and the resulting parameters are easily explained.

On the other hand, unrestricted neural networks better describe nonlinear relationships and interactions and may thus explain more criterion variance. For example, biodata or personality variables appear to predict turnover better when the method used is a neural network than when multiple linear or logistic regression are used. Further, neural networks are more robust than linear discriminant analysis where data may be missing, a common condition in industrial psychology.

Neural networks address a need for arbitrary nonlinear multivariate modeling in organizational contexts, as well as in other areas of psychology. The reason this need exists can be explained with two propositions. One proposition is that not all relationships between meaningful psychological measurements are linear in nature. The second proposition is that because linear methods have been readily available, those relationships which can be described well by a line or plane are likely to have already been studied and described, compared to those which cannot. The set of linear true relationships has been tapped into by investigation, and the set of nonlinear true relationships has barely been touched.

When should a researcher consider linear modeling to have failed? When low effect sizes and lack of significance occur, the usual suspects are various forms of measurement error, including poor reliability of measures, and the moderating effects of additional variables. However, a weight of accumulating evidence, such as repeated fruitless efforts to improve measurement, may indicate a misspecified model. When the components of the model make both theoretical and “common” sense, the next suspect is the mathematical form of the model. Further evidence may come from residual plots and other visual diagnostics, but the relationship may not be easily perceived because of its still-small effect size, or it may require multiple predictor dimensions.

As an example in organizational psychology, consider job satisfaction and job performance. It is intuitively obvious that the two should be related, and yet many studies have failed to find a clear relationship. One recent study found a nonlinear relationship between those two variables and either role conflict or job involvement. In the space defined by role conflict and job satisfaction, or job involvement and job satisfaction, there were regions in which the effect of job satisfaction on job performance was strong—very nearly a step function. In other areas, however, there was little effect of small changes in either predictor variable on job performance. In this case, measuring a variable such as job satisfaction across a wide range, or over the wrong narrow range, would lead to a lowered slope in a linear fit. Under the assumptions of the linear model, it is irrelevant whether the experimenter measures the right range of a given variable, so a solution leading to more consistent and theoretically sensible effect sizes was not apparent.

The assumption of linearity, inherent to most psychological studies, can be subject to empirical test. Such a test can evaluate the fit of the linear model by comparing it to an arbitrary nonlinear model such as the neural net, rather than being an error-prone visual assessment conducted by the experimenter.

For the problem at hand, it is convenient that a neural network will model either a linear relationship or a nonlinear relationship equally well. The form of the model is not as important as the quality of the resulting predictions. It is possible that in predicting a given employment outcome, even a neural network will discover only linear relationships, and a linear regression model would predict the outcome just as well. Experience suggests it is likely, however, that at least one of the variables has a region of particular sensitivity, an optimal point, or a non-additive interaction with another. Therefore, the more flexible model, the neural network, will be used.

### Example 55

### Exemplary Neural Network Architectures

There are several architectures under which neural networks may be constructed. Not all of them are discussed here. Specifically, the architectures can be divided into two broad classes based on the type of problem which they are designed to solve, and the type of training they undergo.

The first type includes networks that produce feature maps, clusters, and other descriptions of the data without reference to a criterion. They are trained by unsupervised learning, that is, also without reference to a criterion. These are useful for some purposes, such as the organizational commitment study mentioned above.

The second type are trained to predict a criterion, using examples where the criterion as well as the predictors have been measured. This process is known as supervised learning, because it involves a “supervisor” to check the network's prediction for each case at each step of training and send back a description of errors made. The parameters of the network are then adjusted to reduce the error. In this way, the network's predictions are tuned to the data.

Supervised learning may be considered a one-step form of pattern recognition, as opposed to the classical two-step form in which feature extraction precedes prediction according to features. Other than behaviorists who treat the brain as a “black box,” psychologists typically use the second form; we first define constructs, and second develop a theory of how those constructs lead to observed behavior. Neural networks do not require the specification of meaningful constructs. Multilayer networks do perform an additional step of feature extraction beyond that involved in measuring the inputs, but the only labeling of the features is the equation relating them to the criterion.

Not all architectures within this category are useful for our purpose, but many are. One useful limitation on the architectures is that they be feed forward networks. That is, information flows in only one direction (excluding error data during training), from the inputs toward the outputs.

The alternative is a recurrent architecture, which has one or more loops internally, such that internal components of the network may contribute to their own states. A recurrent network thus has a “memory” for one or more previous rounds of calculation.

There are several types of feed-forward architecture. One example is the multilayer perceptron, but the results generalize to other types.

The perceptron is one form of neural network, and the multilayer perceptron is a homogenous evolution. It is relatively transparent mathematically.

The multilayer perceptron is composed, as its name implies, of layers of nodes. Each node is an identical functional unit, described below, which accepts inputs and produces an output. The outputs from the nodes on one layer are the inputs to the nodes on the next layer.

There are at least three layers of nodes in the multilayer perceptron; other perceptrons have only two: input and output. Input nodes are those that represent quantities extrinsic to the network; output nodes are those that produce the neural network's responses. The multilayer perceptron has additional layers between the inputs and outputs, and need not have direct connections from input to output. These in-between layers are called hidden layers. Their states are not typically meaningful in a concrete sense, and they are generally not reported, but they greatly increase the modeling power and therefore usefulness of the network.

Perceptrons lacking hidden layers can typically only distinguish linearly separable sets. Information can be presented in the right form, be that a ratio, a power of an observed quantity, or some other transformation. Consider, for example, the set of points within a radius r of some center and those which are outside r, with each point given as a coordinate pair to two inputs. Although the condition is simple, a perceptron could not approximate it to any great precision. However, in cases such as this where the sets are nonlinearly separable, the presence of a hidden layer can allow for an arbitrarily adjusted nonlinear transformation into an alternate space where the sets are linearly separable—for our example, some arbitrarily good approximation of radius-angle space.

Theoretically, only one hidden layer is required for even the most complex relationships. Additional layers sometimes provide a more parsimonious or understandable explanation, however. This is most justifiable when the researcher knows a priori that there are higher-order relationships present in the data. Up to three hidden layers, or more can be used.

The default configuration of a multilayer network is to have each node in a given layer receive for its inputs the states of the nodes in the previous layer. This is known as being “fully connected”. However, if the researcher knows something about an overarching structure connecting the inputs, some connections may be “pruned”. This means that the receiving node only accounts for information from some of the nodes in the previous layer. If it is possible to prune a network from a priori knowledge, it is advisable to do so, as it can avoid noise.

In some of the example, structure known prior to transmission of any data is imposed on the neural network.

The structure of each node can be identical, and can be described by the equation:
output=f(weights·inputs) (1)
where weights and inputs are vectors of equal length, and output is a scalar quantity.

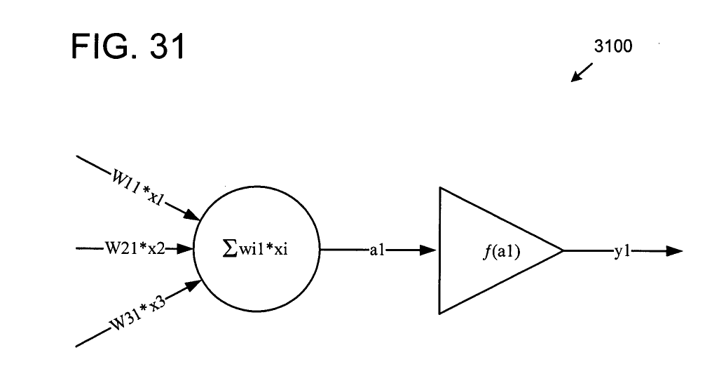

The node is usually represented diagrammatically with two parts, as shown in FIG. 31 which shows an exemplary node 3100 of a perceptron. The first part is a summation. Specifically, it is a weighted sum of the inputs to the node, represented by the dot product of vectors in the equation above. There can be exactly one input which does not come from a previous layer; it can be set to unity, and the weight by which it is multiplied is known as the bias.

The second part is the transfer function, f( ), which scales and transforms the weighted sum into an output. In the simplest case, the transfer function is linear: f(x)=ax+b. In this case, the computation of the multilayer perceptron can be reduced to matrix algebra and cannot model nonlinear relations between variables.

A common transfer function is the step function, set equal to 1 above a threshold value and 0 (or −1) below it. This is a transfer function, and may be implied by the use of the term “perceptron”; although the term can be used more liberally. Several variations on the binary step function exist, including trinary step functions which report 0 at the threshold, 1 above, and −1 below. Clipped linear functions restrict output values to a specific range while maintaining linearity.

The transfer function need not be monotonic. In some cases, Gaussian distributions are used. These are localizing functions, which essentially report whether the sum of inputs falls within a particular range.

A set of functions that are smooth, differentiable, and monotonic can be used. This class of functions, the sigmoids, can be commonly used. It includes the normal ogive, otherwise known as the cumulative normal distribution. The logistic function, when compressed horizontally by a factor of 1.7, falls within 0.01 of the normal ogive at all points and is for practical purposes equivalent. A third function, the hyperbolic tangent function, is a further rescaling and vertical shifting of the logistic, in order that it ranges from −1 to 1 instead of 0 to 1 and be antisymmetric around 0. This can improve the speed and probability of success of the training process.

The multilayer perceptron is one example of a continuous function estimator. Provided that it has at least one hidden layer with a nonlinear transfer function, and provided sufficient nodes and training cases, a multilayer perceptron can approximate any continuous function arbitrarily precisely. This can be shown by the universal approximation theorem. In practice, one is typically more concerned with overfitting the training data set, including modeling error, than with having too few parameters to fit the real variation. Overfit leads to poor generalization to future data points which have errors independent of any of the training cases.

In light of their ability to model arbitrary continuous function surfaces, three-layer perceptrons are excellent for predicting near-continuous data such as revenue per hour, as well as job tenure, dollar amount of theft, and other business metrics.

To predict qualitative or otherwise non-continuous data, one may divide the cases at a threshold output level. This can result in a classification. If there are more than two categories, the network can be trained to produce a separate output for the probability of membership in each possible category. This can be used, for example, in the prediction of separation reason. However, there are more efficient ways to go about it, which may result in better predictions. A multilayer perceptron may have more than one output, giving a probability of membership in each category. Similarly, several networks may be trained, one for each category; this, however, allows the possibility of two categories being predicted. Finally, other network architectures may be better suited to categorical prediction.

### Example 56

### Exemplary Properties of Neural Networks

There are several properties of neural networks which can be of use in adaptive input selection. These properties are not specific to the multilayer perceptron or to the radial basis function, but apply at least across the entire class of feed forward networks which are trained by supervised learning.

In devising an algorithm to feed information adaptively to a neural network, we will be concerned with error of prediction. Specifically, we will be concerned with changes in the amount of error. The problem of describing the errors the network commits arises in the context of training the neural network. Optimizing predictive accuracy can involve a way of describing the errors the network commits in predicting the training cases. Typically, a scalar error function can be minimized by a variety of methods. These methods refer to a “performance surface,” where the error quantity is treated as a function of the adjustable parameters of the network. In the case of the multilayer perceptron, the parameters are the weights, including the biases, entering each node. In the case of the radial basis function, the parameters also include radii and centers of the hidden nodes.

The error function is usually the sum of squared differences between the actual levels of the outcome variable and the corresponding predicted levels in all the training cases. Variations include the mean squared difference. The choice of this function was based on the assumption that errors will be distributed normally, but the use of the least squares method does not require that assumption. According to the Gauss-Markov Theorem, the only requirements are that the errors be independent and identically distributed with finite mean and variance. Several alternative performance measures can be used, including entropy.

Neural networks have the property of graceful degradation in the presence of erroneous data. In the general case, this only means that the functions they fit are continuous and thus that small perturbations of inputs result in small perturbations of outputs. However, if a bounded transfer function is used between layers, the neural network will still give a similar output even if one or more inputs are replaced with an extreme or nonsensical value.

It was typically assumed that there is a value for each input. That may mean that a default value is substituted for missing data, or that a random or erroneous value is expected. Regardless of the value of any given input, the other inputs still meaningfully restrict the possible range of the output. The uncertainty of the output value decreases monotonically with each input which is known to be valid. It also decreases monotonically with the uncertainty of each input, so that if one input is restricted to a subset of all possible values, the output is restricted as well.

In applications of neural networks, missing data was not intentional on the part of the developer, and values which are not missing (or which are substituted for missing data) are considered exact. The missing data may be accommodated either as unsystematic, through the network's general robustness, or as a systematic indicator of a failure condition. In the latter case, the missing data code is a relevant value in itself, if it is available. Unsystematic substitutions for missing data may not result in a distinct code, but a random value. This happens, for example, in mechanical systems where input-generating components may be susceptible to analog “noise,” or in electronic network communications where single-bit errors may be introduced. This type of substitution is less diagnostic; the network only knows there is an error if the value violates the expected relationship between inputs. Even then, it may only be possible to tell that an error is present, not identify which input gave the bad value.

Uncertainty about measured values due to measurement error is typically either not accommodated, or implicitly accommodated by the training set. In mechanical applications, the error of a particular instrument is likely to be constant over time. It simply increases the unaccounted-for variation after the relationship between input and desired output is measured.

In examples described herein, inputs are sometimes missing by design, although the training set may have no missing data. Further, some measurements which are entered as inputs have error quantities which change over time and which are large enough to change the output. A numerical method for estimating the effect of incremental uncertainty in the inputs on uncertainty in the output is described.

Another quantity that can be useful is the sensitivity of an output to an input. This is the amount of variation in the prediction that results from small perturbations in a given input. If a nonlinear transfer function is used, this sensitivity will vary across the values of each input, including but not limited to the input for which it is being calculated. For that reason, it can be calculated as a partial derivative of the output with respect to the input, with the other variables left in the equation.

### Example 57

### Exemplary Computer Adaptive Testing

A computerized adaptive test (CAT) can include any test which meets two criteria. The test is administered by a computer, making it computerized. Further, over the course of the test, the examinee's performance can influence the items presented. Computerized adaptive testing can include a form of computerized adaptive test that estimates a unidimensional latent trait according to the principles of item response theory. The examples described herein include CAT that does not adhere to this form.

Adaptive testing has several advantages over conventional testing, particularly when computers ease the computational burden. These advantages are above and beyond those conferred by computer administration.

First, CAT can allow more even measurement across the entire range of a trait. A conventional ability or skill test, for example, typically contains items that are easy, moderate and difficult. Almost all the items provide information about an examinee of moderate ability. However, an examinee of high ability who demonstrates proficiency on the moderate items can be expected to answer the easy items right; they provide no additional information because they have zero variance. Similarly, an examinee of low ability can do nothing more than guess wildly at difficult items, adding noise to any estimate of their ability. The result is that the standard error of measurement is not constant across the range of ability, as classical test theory would suggest. Error is inflated and reliability is decreased for high or low ability examinees.

CAT can use early items to target the difficulty of later items. An examinee who shows proficiency early on will receive more difficult items than one who answers the first few items incorrectly. This means that examinees at either end of the ability range answer few non-informative items, and more informative items. These “extra” hard or easy items reduce the standard error of measurement in the high and low ability ranges. The CAT is still not likely to produce exactly the same standard error of measurement in the same number of items for every examinee, but it can be closer to that ideal than the conventional test.

These effects are not limited to ability; an analogy can be made to any unidimensional construct. Ability is convenient in that the terminology is familiar.

By the same mechanism, adaptive testing is faster than fixed-sequence testing for the same precision of measurement. Computerized tests, given a variety of items, may achieve excellent performance after asking a small number of questions.

In order to consider the technical issues involved in using CAT in conjunction with neural network scoring, the mechanics of CAT can be examined. Components may then be systematically replaced, without changing the broad principles of operation. There are two components that can be of particular interest. One is the item selection algorithm, according to which the next item is chosen. The other is the scoring rule, a mathematical procedure according to which the examinee's item responses are converted to a score. If the scoring rule is a neural net, how can the item selection algorithm be changed?

CAT can be an assessment devised to measure a unidimensional construct such as (but not limited to) ability. The principles of item response theory may be applied to both item selection and examinee scoring.

The test can measure a single latent trait, on which the examinee's true score is θ. An approximation of θ, \hat{θ}, is available at any given time; \hat{θ} is used to select the next item according to its difficulty (and possibly other parameters). A convenient feature of item response theory is that the item and the examinee may be placed on the same scale. An informative item is therefore one whose information function is high in the neighborhood of \hat{θ}. The information function is defined as the derivative of the probability of a keyed response with respect to θ, and therefore it can also be said that an informative item is one for which a small difference in the latent trait makes a large difference in observed response. In the simple case of items which conform to a one-parameter logistic model, the most informative item is the one whose “difficulty” most closely matches \hat{θ}.

Several similar scoring rules can be accommodated, each of which correspond to a slightly different item selection algorithm. Maximum likelihood estimation or Bayesian inference techniques can be used. The primary difference, not affected by technological capabilities, is whether \hat{θ} should be calculated conservatively according to assumed population parameters, or purely according to the examinee's responses.

An estimator that can be used for θ is the expectation a posteriori (EAP) value, which unlike the maximum likelihood value is robust to bimodality and other distributional anomalies that may arise. In any case, once the item is selected and responded to, the distribution from which the examinee is assumed to come is updated according to the scoring rule. At first, the examinee is assumed to come from the distribution of all examinees, which may be constant (as in the case of maximum likelihood estimation), normal with zero mean and unit standard deviation, or an arbitrary distribution corresponding to a known population subset. After one item, the examinee can be assumed to come from the distribution of all examinees who made one particular response to that item. After the second item, the distribution is restricted by two responses, and so on. The process of updating from one distribution to the next can amount to a convolution of the existing distribution with the characteristic curve for the given response, where the characteristic curve is the function relating θ to the probability of giving that response. \hat{θ} is recalculated from the new (posterior) distribution; in the case of the EAP, it is the mean.

In variations of CAT, the scoring rule and the item selection algorithm can be intertwined with and optimized to each other. In order to use a scoring rule which is not based on item response theory, an item selection algorithm can be devised to match it. Not all scoring rules have the mathematical conveniences of item response theory, such as the examinee and the item being on the same scale. However, functional equivalence is possible.

Computerized adaptive testing is occasionally applied to situations in which only a pass/fail judgment is required, not a relative score which may be compared to other examinees. This may well be the case in an employment setting, where the test may be used as an early screening, followed by more intensive evaluation. However, if the cutoff score is known in advance, it is more efficient to target the items to maximally discriminate at the cutoff level, not at the examinee's probable ability level. The cutoff need not change, so there is no need to make the test adaptive. If additional information may be useful, but there is a threshold value which is important, a technique can call for a CAT with an item pool distributed such that most of the items measure near the threshold. That way, it is still possible to identify an outstanding candidate, but ones who are near the threshold are measured with a high degree of precision. It is not necessary to know how far below the threshold a candidate falls, merely to be certain that the candidate did fall below threshold.

Mastery testing can involve a cutoff score that is relatively permanent, and thus there is no need to address the situation of when the threshold is subject to revision after the item pool is fixed, a situation that may come up in employment contexts. If an employer may lower or raise the threshold depending on the availability of job applicants during a given time period, then targeting the entire item pool to the cutoff score is shortsighted. Targeting a given test, however, may be a viable option.

The cutoff argument, while presented as unidimensional in the context of mastery testing, may be generalized to the prediction of category membership in multiple dimensions. In general, it is advisable to consider whether there are regions of latent trait space where information is more valuable; otherwise, one implicitly assumes equal value throughout that space.

### Example 58

### Exemplary Subsets and Scoring

A major difference between the tests typically converted to computerized adaptive form and assessments of personality in the prediction of employment outcomes is that the latter are typically not unidimensional. Job performance and job tenure are composite criteria, influenced by several variables. An assessment may involve several corresponding variables, particularly if biodata are used.

In scoring such a multidimensional test, it is useful to know what dimensions are being measured. This is not only for the purpose of interpretation; it anticipates the need for diagnosis when, for example, a social change leads to the erosion of validity. If interpretation is to be done, the theoretical expectation that certain items will measure certain constructs can be verified empirically. When the dimensional structure of the assessment is understood, unidimensional subscales may be constructed such that they exhibit internal consistency.

The use of subscales both complicates and simplifies the selection of items. From the perspective of a neural net, a well-constructed scale reduces largely redundant information to a single estimate with less noise. This reduces the number of training cases needed and may improve performance, because the data points are located in a lower dimensional space. However, the trait estimate produced by a subscale is qualitatively different from a direct representation of an item; it is continuous and comes with an uncertainty, whereas an item response is categorical and concrete. Either the applicant chose “1” or he did not. For this reason and the length of application, a subscale requires differential treatment by the selection algorithm to be developed. Nevertheless, efficiency of training outweighs elegance of the selection algorithm. Subscales can be used in any of the examples herein.

Factor analysis can be used to determine the dimensionality of a set of items. Factor analysis is, however, only one of several methods. It may not be the most appropriate method for item-level personality data. Factor analysis assumes the items are continuous, and many of its significance tests further assume the responses are normally distributed, but a more likely case is that each item has only a few discrete possible responses. This case can lead to underestimated loadings and overestimates of the number of factors present. It is also subject to a form of indeterminacy which is likely in this type of application. Doublet factors, or constructs which are represented only by two items and which are not correlated with other factors, can result in improper solutions (negative variances) or solutions which do not accurately reproduce the underlying structure, and thus cannot be expected to replicate in independent datasets.

Test questions can be independently sorted into groups by content and each group named. The group names resulting can be compared and nomenclature chosen. Then a consensus can be reached about item placement, entirely without reference to examinee data. Finally, reliability can be calculated for each resulting subscale and items with intraitem correlations consistently below 0.1 can be dropped.

Variations on the exact method can be done. The significance, however, is that empirical exploratory methods may be entirely bypassed when the theory linking item content is strong. It is also worth noting that neither the confirmatory evaluation of internal consistency, nor further assessments of convergent validity need be bypassed. Those confirmatory evaluations can be considered valuable, even when the exploratory analyses were not.

When criterion data is available, another method may be used, that makes no reference to factor analysis. Instead, the method of criterion-keying can be used: items can be chosen on the basis of their ability to discriminate criterion groups.

This method is unconventional in psychology, where construct validity may be favored over criterion validity. Criterion-keyed traits may disagree with those which are gleaned from factor analysis, and may or may not achieve high reliability. Some tests which predict occupational outcomes may do so by predicting several intermediate behaviors which contribute to that outcome.

Cluster analysis is another set of methods related to factor analysis. Items can be clustered according to correspondence across individuals. Methods such as agglomerative nesting may produce a useful atheoretical guide toward linking items. As with criterion-keying and content-based sorting, empirical validation is still called for.

Any of the methods described above can be used in conjunction with each other to provide converging evidence for the dimensional structure of a test. In some of the examples herein, any (e.g., all except factor analysis) can be used in the development of the subscale structure. Final decisions about inclusion and exclusion of items can be made on the basis of incremental reliability and expert judgment regarding content. An example where expert judgment overrode reliability involved the high correlation of a risk-taking item with several sociability items in a population of athletes. The correlation was not expected to generalize.

Provided that each scale is defined without distinguishable subsets of items which are more intercorrelated, constituting a local independence violation, the subscales can be assumed to correspond in a one-to-one fashion with latent traits of the examinee. This is in contrast with the entirety of the assessment, which predicts a single employment outcome but contains more tightly coupled scales within itself. Thus, for each subscale, a latent trait (or item response theory) model may be applied to its items.

Item response theory (“IRT”) models can be extended to multidimensional tests. These methods allow each item to provide what information it has available to the estimate of the examinee's placement on each dimension, in contrast to having several independent measures of the different dimensions. A factor analysis can assume that polytomous items call for a linear combination of several latent traits. That is, each item has a “direction of measurement” vector in a space defined by several traits, and can be described by a one-dimensional curve along that vector. A “noncompensatory” model in which several abilities are required to solve a problem can be used. The non-compensatory model need not predict that an examinee high on one quality can make up for a low score on another. This model cannot be described by a one-dimensional curve along a “direction of measurement” regardless of perpendicular position.

The latent traif model focuses on shared variance among a set of items. That shared variance is considered to be the best measure of the underlying trait. Sum scores and more complex trait estimates discard unique variance which is not common to the set of items as a whole. This can have two consequences.

First, the reduction of a set of items to a superior measure of their shared variance is the reason that a trait estimate can be used as a form of compression of the item responses. If the latent trait is what predicts the outcome, then unique variance of each item is just noise. The principle of local independence implies that the noise is random and will, on average, cancel out.

Second, the removal of unique variance may remove useful variance. Based on the multidimensional nature of job performance, heterogeny in the test as a whole can be used, including shorter and less internally consistent scales, in order to better sample the range of personality traits affecting a performance measure. Further, it is possible that an item response may be driven by both a trait which other items also measure, and a second trait which is linked to the criterion but not measured by other items.

In order to preserve useful unique variance, as well as justify the assumption of local independence, items which appear to be internally complex or which do not link strongly to scales can be scored individually, not entered into scales.

### Example 59

### Exemplary Adaptive Assessment Technologies

Neural network modeling and adaptive testing can be combined.

Item response theory need not be used for parameter selection and to guide item selection. When using neural networks in employee selection, it need not be assumed that all input data is present, or is missing completely at random.

Adaptive testing and neural network scoring can be used with a set of rules to govern which items are presented and omitted, and to interpret the output of a neural network whose input data is missing in ways constrained by present data.

In some examples, an adaptive selection technique suited to a test scored by a neural network for a single criterion is shown. In computerized adaptive testing, the item selection algorithm and the parameter estimation algorithm can be separated from the rest of the mechanics of testing. It is not necessary for these parts of the program to know about the content of the test, the specifications of the computer, or specific user behaviors such as mouse movements. Such issues can be addressed by a fully operational program for adaptive testing.

Approximate solutions will be given in some cases to improve computational efficiency; although elegant solutions may be described, these approximations may be preferred for performance reasons.

Item selection can include three rules. First, a rule for selecting the first item, such as “Present item #1” or “Present the item with a difficulty closest to the mean ability level in the population.” This may be a special case of, or separate from, the second rule, which governs how subsequent items are selected when some information is known about the examinee.

The third rule governs when to stop presenting items, and may be as simple as “Stop presenting items when ten items have been presented.” Alternative stopping rules, however, can include a maximum standard error with which an examinee may leave the test. When the examinee is measured to that precision or better, the test ends. In some testing circumstances, fixed-length tests may be desired rather than fixed precision tests (e.g., on the basis that an examinee who fails the test after a small number of items may feel that he has not been measured adequately to justify his failure, particularly in high-stakes contexts). When the stopping rule executes, the testing program can produce a score (or a pass-fail judgment). A measure of either reliability or error of measurement can also be produced.

The second rule is sometimes called “the continuing rule” or “next item selection.” Specific rules for a selection algorithm can be influenced by an estimation procedure, which can maintain the score and error estimates.

The behavior of the estimates produced when some of the input data are held constant and others vary can be observed, representing the situation in which some values are uncertain. A series of increasingly complex examples can be described to illustrate these behaviors.

In the examples that follow, a neural network can be trained on a list of B biodata variables such as credentials and job experience (“biodata”), a list of I Likert-scaled or multiple choice items (“items”) which may take on any of V integer values, and a list of S continuous-valued scales (“scales”) with mean zero and standard deviation one. Adaptation can occur in the items and scales. The biodata questions can be designated as mandatory to present (e.g., according to legal or functional requirements). To achieve maximum benefit from the adaptive process, the biodata questions can be presented first.

In the examples, the neural network can have a multi-layer perceptron architecture (e.g., three-layer); alternate architectures can be implemented (e.g., via re-derivation).

### Example 60

### Exemplary Scenario Involving all Items But One Present

In this particular case, all data is presented to the fully trained neural network except for one item, iε{1, 2, . . . I}. Disregard for the moment how this one item was chosen to be omitted. Assume also that the biodata can be represented by a vector B of integers, and that the information resulting from the administration of S scales can be represented by an S-dimensional vector \hat{θ}. That is, both are point estimates recorded with no uncertainty. Despite the estimation notation, \hat{θ} here is the final value, equivalent to the value on which the neural net was trained, and may as well be the true value because its uncertainty has been discarded.

The item may take on any of V values, leading to V different input patterns which may be presented to the neural network if the last item is presented. Each of these V input patterns will cause the neural net to produce an output; these outputs may be the same or different. Select one value of this item, vᵢ. Then vᵢ has a probability
pᵥ_{ᵢ}=P(vᵢ|\hat{θ},B,v_{j≠i}) (2)
where v_{j≠i} is the vector of the I-1 known item responses. Given each complete input pattern, the neural network produces a value y. It follows that the distribution of predictions output by the neural network will have Y≦V possible values, because two input patterns may generate the same output pattern, but each input pattern results deterministically in a single output pattern. The probability of output y, drawn from this Y-valued set, will be
p_{y}=P(y)=pᵥ_{ᵢ}*P(y|vᵢ,\hat{θ},B,v_{j≠i}) (3)
P(y|v) is, in this case, a binary value: is the output of the neural net equal to y given the specified input values, including vᵢ? The probability notation is used for consistency with subsequent examples.

Two descriptions of the output distribution can be provided for either the next-item procedure or the stopping rule to evaluate. The first is a point estimate of a measure of central tendency, such as the mean value in continuous cases or the most likely value in discrete cases. When the stopping rule executes, this value can be returned as the score. An estimate of measurement precision can also be provided; the next-item procedure to be developed will depend on changes in this quantity. The variance of the output distribution serves this function in continuous cases, and is mathematically convenient. In our example case, the mean corresponds to

$${\sum }_{y}^{} ( y * {p}_{y} ) \qquad ( 4 )$$

and the variance is

$${\sum }_{y}^{} ( {( y * {p}_{y} )}^{2} ) - {( {\sum }_{y}^{} ( y * {p}_{y} ) )}^{2} . \qquad ( 5 )$$

Although the mean given above is equal to the network's prediction of the criterion, the variance is not representative of the imprecision of that prediction. It is a measure of the uncertainty surrounding the examinee's final score if the examinee were to complete the entire assessment. This variance may be added to the variance of the criterion expected for examinees whose final scores are equal to that mean value; the result is the expected variance of the criterion given the current best prediction.

### Example 61

### Exemplary Scenario: Two Items Missing

With the presentation of the last item thus modeled, consider the presentation of the second-last item from the pool. This item has V possible values vₕ, and for each of these, the V values of the remaining item lead to several possible outputs as described above. Define Y now as the set of possible outputs resulting from the V*V possible response combinations to the two remaining items. We may still say that vₕ has a probability
pᵥ_{ₕ}=P(vₕ|\hat{θ},B,v_{j≠h,i}) (6)
Similarly, each possible output still has probability
p_{y}=pᵥ_{ₕ}*P(vᵢ|vₕ,\hat{θ},B,v_{j≠h,i})*P(y|vₕ,vᵢ,\hat{θ},B,v_{j≠h,i}). (7)
While this equation appears unfriendly, it may be simplified considerably if certain assumptions are met. Two cases are both likely and useful to consider.

In the first case, the I items which are not members of subscales are uncorrelated.

This is the ideal case from the standpoint of the neural net; it means redundancy (e.g., all redundancy) has been accounted for by the use of the subscales. If the stand-alone item responses are statistically independent of each other and of the subscales, then P(vᵢ|vₕ, \hat{θ}, B, v_{j≠h,i}) will be equal to P(vᵢ|B); this distribution of responses will be constant regardless of how many or how few other responses have been made. P(vᵢ) could be independent of B, but this is not necessarily of great import as B is known prior to administration of the adaptive test.

In the second case, the I items are related to each other and to the scale scores only by a common factor, which may be a nuisance variable. (If the common factor is not a nuisance variable and the correlations are strong, CAT based on testlets and item response theory may be used.) This is the case if, for example, the items are susceptible to social desirability (“faking”) effects. Examinees may be more or less inclined to present themselves favorably. This results in low but positive correlations between items in the socially desirable direction, even if those items are not all oriented the same direction in terms of the criterion. In this case, analytic computation of the outcome distribution is less straightforward, but still better than the general case.

### Example 62

### Exemplary Scenario: Many Items Missing

By induction, the formulae developed for one and two missing items may be extended to the case of an arbitrary set of items missing. Define Iₖ as the set of item responses known, and Iᵤ as a set of responses that may be made to the remaining items.

Then

$${p}_{y} = P ( y \vert \hat{θ} , B , {I}_{k} ) = {\sum }_{{I}_{u}}^{} ( P ( y \vert {I}_{u} , \hat{θ} , B , {I}_{k} ) * P ( {I}_{u} \vert \hat{θ} , B , {I}_{k} ) ) . \qquad ( 8 )$$

Analytic evaluation of the mean and variance of the expected outcome distribution becomes impractical quickly, particularly in the case where inputs may be correlated. A numeric approximation can be constructed with arbitrary precision.

A method of multiple imputations can be used to handle missing data in statistical models. It calls for the substitution of “plausible values” in place of missing data, rather than a default value such as the mean of each distribution. Plausible values can be implemented as random numbers which are scaled to the input ranges or recoded to the input values, and then filtered according to the input distribution. Computation based on this substitution is imputation; the “multiple” part of the method comes in when the computation is repeated with numerous sets of plausible values. Multiple imputations give an approximation of the expected outcome distribution.

In a procedural sense, the use of imputation can operate as follows. Two random numbers, drawn from a uniform distribution between zero and one inclusive, are generated for missing items. The first is converted into an admissible value for an item response. The second is compared without transformation to the expected probability of that item response. If it is lower, the value is accepted as plausible; if it is higher, it is discarded and new values are drawn.

The preceding description implies that each value is accepted or rejected separately. This is the case if and only if the remaining items are assumed to be independent of each other when conditioned on the known values. This is true if the items are actually independent, and it is approximately correct when the items are related only by a common factor. In the latter case, the expected distributions of each item can be adjusted based on the level of the common factor estimated from the observed data. The adjustment can be made based on item response theory, linear regression, or another technique to result in a small correction.

If the items are not conditionally independent of each other, plausible values can be accepted or rejected jointly. This is much more computationally intensive. Also, in this case, representing the joint probability distribution is complex and requires very large amounts of data; a neural net can be used as the filter device, trained to predict the plausibility of sets of values.

Once an acceptable set of plausible values has been obtained, the observed and plausible values can be fed to the neural net as inputs, and an output value is calculated. This procedure is repeated, each time with a new set of plausible values, for a specified number of iterations N. The result is a sample of N data points drawn from the distribution of output values which may be expected for this examinee. The mean and variance of this sample estimate the mean and variance of the theoretical distribution, and may be used in their place for the selection algorithm's calculations.

### Example 63

### Exemplary Error of Measurement and Candidate Selection

At any given time during the test, an estimate can be available of the error of measurement (e.g., not from the true score or the actual employment outcome, but from the value which would be obtained if the entire test were administered). This error is expected to decrease monotonically as additional items are administered, and becomes zero when the last item is completed. It is possible and useful to quantify this decrease.

Let item i be any item, but not the last available. Let Iₖ be the set of responses to items administered; Iₖ may be the null set. Let Iᵤ be the responses that will be given if and when each additional item is administered, not including i. The incremental reduction in variance due to administering a shorter test when item i is administered is equal to

$$Var ( current ) - {\sum }_{i}^{} {p}_{vi} * Var ( with {v}_{i} ) = {\sum }_{y}^{} ( {( y * P ( y \vert \hat{θ} , B , {I}_{k} ) )}^{2} ) - {( {\sum }_{y}^{} ( y * P ( y \vert \hat{θ} , B , {I}_{k} ) ) )}^{2} - ( {\sum }_{i}^{} ( {p}_{vi} * {( {\sum }_{y}^{} ( y * P ( y \vert \hat{θ} , B , {I}_{k} , {v}_{i} ) ) )}^{2} ) ) . \qquad ( 9 )$$

Solving this equation can involve estimation of V+1 variances by separate imputation. One is the current variance; the other V are estimates of what the variance will be if the examinee selects one available response.

On the basis of this model, a candidate rule for selecting subsequent items can be used. The rule may be stated as, “Choose the item which, in expectation, reduces the variance of the output by the greatest increment.”

Computationally speaking, this can involve a form of look-ahead procedure. For each remaining item, estimate the incremental reduction in variance, delta-variance, according to the formula already given. Choose the item with the highest delta-variance. Then discard the list; once another item is administered, the second-most-informative remaining item may not become the most useful. This situation does not require a violation of local independence to exist.

If there are Iᵤ items remaining, the incremental reduction in variance can be estimated for each one. Although each incremental reduction calculation can involve V+1 error variance estimations, the look-ahead procedure can be done with only Iᵤ*V+1, because the current variance estimate may be re-used. Nevertheless, because each estimation by multiple imputation can involve a large number (e.g., 1000) neural network predictions, the procedure can be computationally demanding. Nor is it amenable to pre-computation, because of the complex relationships that may exist between items and biodata. A look-up table for a five-item-long test from an item pool of thirty might easily have over twenty four million cases, and that number scales exponentially with the length of the assessment.

### Example 64

### Exemplary Uncertainty in Latent Trait Values

In some examples, the scales have been represented only as a point estimate, a vector of S exact values. It can further be described how those values were calculated, how many items have been asked from each scale, or both. Because the scales are known to measure univariate constructs, they can be estimated using item response theory (“IRT”). One of the advantages of IRT-based estimation is the ability to report the error associated with such an estimate, or even a probability distribution for the location of the true latent trait value. Let us consider the latter possibility. For S scales, arbitrarily correlated, \hat{θ} is now replaced by an S-dimensional continuous probability distribution,
p_{θ}(x)=P(θ=x), (10)

that is, the likelihood of the true trait values being x, conditioned on responses already made.

The distributed form of \hat{θ} carries through the calculations demonstrated previously. The output values y are now not a list of exact values that may be produced, but a genuinely continuous distribution of unknown form. The mean of y becomes

$$E ( y ) = {\int }_{- ∞}^{∞} ( y * {p}_{y} ) ⅆ y / {\int }_{- ∞}^{∞} y ⅆ y . \qquad ( 11 )$$

The variance is
Var(y)=E(y²)−E(y)². (12)
The sums over possible values of missing data can be integrated across all values of x before comparison, complicating the analytic form further. The difficulty of approximation by the method of multiple imputations is nearly unaffected, however. In a numeric approximation, an integral is just another sum, and this extension simply calls for the inclusion of the elements of \hat{θ} on the list of plausible values to be drawn.

Because the latent traits measured by the scales are arbitrarily correlated, the candidate plausible values x for each \hat{θ} vector should be drawn and filtered simultaneously, according to their joint probability distribution function p_{θ}(x). However, the joint probability distribution function may not be known, particularly if multidimensional IRT methods are not used to model the items. The misfit of the implied joint function that results from drawing plausible values independently can be evaluated on a case by case basis. Where correlations between scales are low or not well known, the degree of misfit may be no greater than that which stems from the assumption of an incorrect distributional form.

Incorporating uncertainty in scale values, as is implied by representing them as distributions, permits a wider range of values of y by spreading out the formerly discrete possibilities along a continuum. It is fair to assume that as the uncertainty in the trait estimate increases, the uncertainty in the output will also increase, or at least not decrease.

At any point during the administration of the items in a given scale, that distribution may be passed along to the neural net. In practice, most neural net programs cannot accept a distribution of values as an input, but the algebraic form allows it. As more items have been presented, the distribution becomes narrower; the error of measurement of that trait becomes smaller. If some subset of the items in a scale is to be presented, regardless of the mechanism, it is worthwhile to consider the incremental effect of input uncertainty on output uncertainty.

For simplicity, first consider the case where all items have been administered. Recall that the change expected in the output per unit change in a given input is the sensitivity to that input, and that the sensitivity

$$\frac{\partial y}{\partial {x}_{s}}$$

is calculated as the partial derivative of the output with respect to that input. The exact analytic form of

$$\frac{\partial y}{\partial {x}_{s}}$$

varies according to the form of the neural network. For any neural network with one hidden layer, define aⱼ as the activation of a hidden node, wⱼ as the weight of the connection between hidden node j and the output, and wᵢⱼ as the weight of the connection between input node i and hidden node j. Define g(a) as the transfer function of the output node, and f(x, B, I) as the transfer function of a hidden node. Then

$$\frac{\partial y}{\partial {x}_{s}} = ( \frac{\partial y}{\partial {a}_{j}} ) ( \frac{\partial {y}_{j}}{\partial {x}_{s}} ) = {g}^{′} ( a ) {\sum }_{j}^{} ( {w}_{j} * {w}_{ij} * {f}^{′} ( x , B , I ) ) . \qquad ( 13 )$$

It follows that the variance in the output which is attributable to uncertainty in the input is

$${σ}_{i}^{2} = {\int }_{x}^{} {p}_{θ} ( x ) * {( \frac{\partial y}{\partial {x}_{s}} ( x , B , I ) )}^{2} * {( {x}_{s} - E ( {x}_{s} ) )}^{2} ⅆ x . \qquad ( 14 )$$

The incremental effect of administering each remaining component item to any of the S scales may be compared by computing V hypothetical p_{θ}(x) distributions, passing them through this formula, and comparing the averaged results to the existing scale-attributable variance, in much the same way as the effect of administering a stand-alone item was calculated. However, this can place a computational premium on having the scales. An approximation can ease the computational burden greatly, while still being unlikely to result in the choice to administer an uninformative item.

If the uncertainty in the scales is small relative to the variation in scale scores across the population, it may be assumed that the output as a function of x is closely approximated by a hyperplane in the vicinity of E(x), where p_{θ}(x) is high. This is true after some items have been administered, and may be true initially due to information from the biodata. The explicit scale-attributable variance function may be simplified with some loss of information by substituting E(x) into

$$\frac{\partial y}{\partial {x}_{s}}$$

(x, B, I) instead of integrating across plausible values. The resulting scalar value may be multiplied by the incremental reduction in scale variance for an estimate of scale-attributable variance.

A more complex case is more likely. This is the case in which some stand-alone items have not been administered, and yet the incremental effect of uncertainty of each scale score is still needed. Assuming either the independence or common-factor cases for item intercorrelations, the exact formula requires weighted summation across the possible values of Iᵤ according to their conditional likelihood, as well as integration across x.

The approximate formula may be estimated by the method of multiple imputations, or, because an estimate of uncertainty of this value is not required, a point estimate of Iᵤ may be used. E(Iᵤ) may be used, following the use of E(x). However, recall that the elements of Iᵤ can be responses to items which may be ordinal or even categorical. In either of those cases, the arithmetic mean may be an inadmissible value, or result in an output which is not actually “in the middle.” The modal value of Iᵤ can be more appropriate. In both the independence and common-factor cases, this value may be easily obtained by taking the value of each element with the highest conditional probability.

### Example 65

### Exemplary Other Item Selection Technique

The approximation of the effect of scale uncertainty on output uncertainty leads to a next-item selection rule, but can be augmented. The technique begins and ends at the level of the scale. That is, the selection algorithm accepts an estimate of reduction in scale variance for each scale, and returns a decision about which scale, if any, to “spend” an item on. It does not control which item within the scale is administered, or consider how that reduction in variance may be achieved. Under this rule, a subordinate function can administer an item, return a posterior distribution as a component of x, estimate the reduction in scale variance from administering the next item (but not do so), and make a standing request for permission to actually administer that item.

If the posterior distribution is to be estimated using IRT from some form of unidimensional item model, it makes sense to use CAT to select the items within the scale. A CAT can maintain a posterior distribution, which can be a list of values of p_{θ} associated with values of θ. It can select the next item based on a maximum posterior precision method, and estimate the variance of the posterior distribution after that item is administered based on a look-ahead procedure. The estimate can be carried out once, without reference to what happens between when it administers one item and the next, because a uni-dimensional CAT need not accept information from other scales. This is a feature, not a bug; it can simplify item modeling. Altogether, this estimation of scale variance reduction is computationally cheap.

The candidate rule for first and subsequent item selection can be revised into a cyclic procedure as follows: “For scales (e.g., each scale), retrieve the expected reduction in variance from administering the next item, and multiply it by a point estimate of the sensitivity. For stand-alone items (e.g., each stand-alone item), obtain the expected reduction in variance by simulating each possible outcome. Choose the item or scale which, in expectation, reduces the variance of the output by the greatest increment when one item is administered. If an item is chosen, administer it and update Iₖ. If a scale is chosen, the subordinate CAT should administer the pre-selected item, update x, select another item for maximum posterior precision, and ‘try out’ the next item to obtain the expected reduction in scale variance. The subordinate CAT can retain this value.”

### Example 66

### Exemplary Alternatives

The context of the selection procedure has many features that can be changed without fundamentally altering the selection algorithm.

The mathematics have been derived without reference to any specific mechanics of the neural net, other than example sensitivity functions. In fact, this procedure does not require that the predictive function be a neural net. Any mechanism will do (e.g., if its output is a continuous, analytically differentiable function of the continuous inputs given any values of the discrete inputs). These are the functions well-modeled by neural nets, but no part or form of neural net calculations, nor any mechanism of fitting the model, is required for the technique to work. Note that some models can be considered special cases, which simplify the calculations—sometimes to the point where the test is no longer adaptive. Multiple linear regression is one such model type.

The rationale for using subscales where items exhibit local dependence has been given, but subscales may simply be omitted if the item pool is appropriate. In some cases, testlets may be used instead of subscales, if the item content calls for it. Testlets can be arbitrarily scored groups of locally dependent items administered together. The selection rule for items can easily be adapted to penalize testlet-associated reduction of variance proportionally to the length of the testlet.

If subscales and/or testlets are used, stand-alone items may be omitted. This can easily occur in more theoretically well-defined areas of testing, such as academic assessment. This simplifies calculations considerably; the predictive relationship is essentially a guide to arbitrating between several univariate CATs competing for an examinee's time. In this case, however, building a fully multivariate CAT with joint estimation can be more effective.

Biodata, or rather, a pre-existing classification of the examinee which contributes information to item selection, is not necessary for this procedure. In applications other than an employee selection context, it may be considered more appropriate to use only population characteristics as a prior distribution (e.g., in educational contexts).

### Example 67

### Exemplary Program

A computer can administer a test after the structure of the test is programmed. The mathematics of scoring and the functional operations of choosing and presenting items, recording and processing data can be defined. A system constructed according to this structure can yield the results shown.

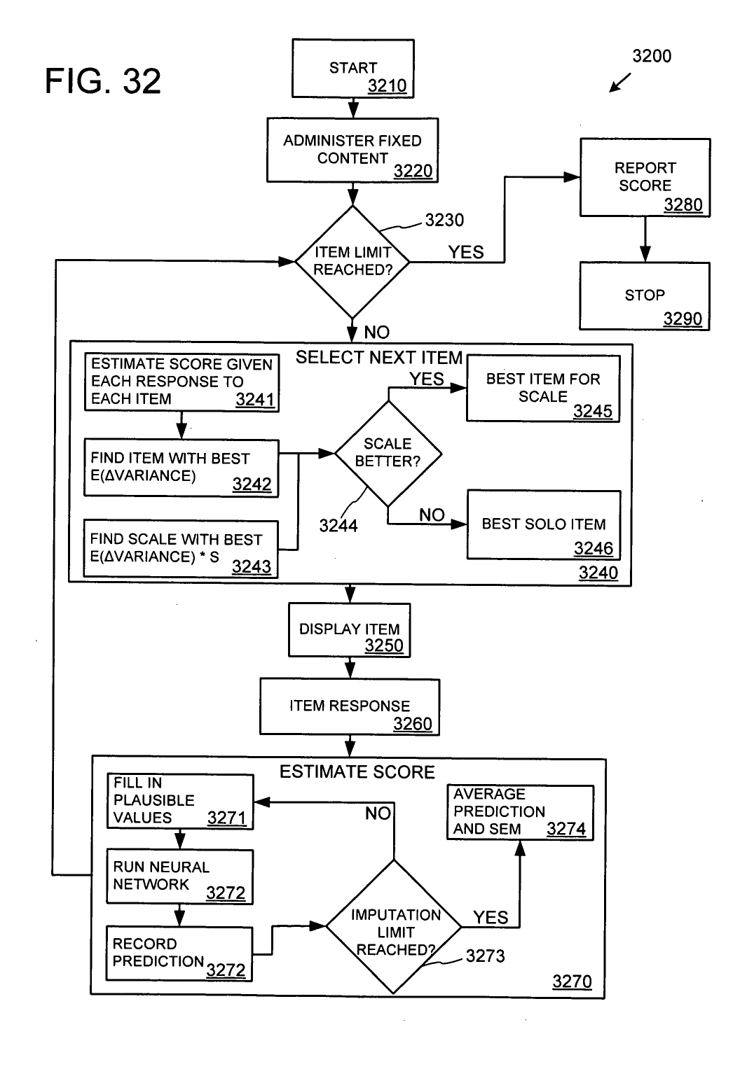

FIG. 32 is a flowchart showing an exemplary method 3200 of administering an adaptive assessment. The flowchart presents a general architecture a program for administering an adaptive assessment in terms of processes. The processes described can be an extension of the three rules described herein: the starting rule, the continuing rule, and the stopping rule.

In the example, the starting rule is as follows: Begin a new log at 3210. Administer any fixed content at 3220, one item at a time, then go to the continuing rule.

The Administering fixed content can be its own trivial loop: Administer a biographical item. Is there another biographical item? If so, repeat. If not, go on. However, the structure of the fixed content administration may be much more complex than this without any effect on the final product.

The continuing rule is cyclic: Test for the stopping condition at 3230. If the stopping condition is satisfied, go to the stopping rule (report the score at 3280). Otherwise, select an item according to the item selection rule 3240. Display the item at 3250, record a response at 3260, and update the relevant internal structures. Estimate a score according to the scoring rule at 3270. Then, go to the continuing rule (test for the stopping condition at 3230).

Recall that the stopping condition may be the attainment of a specified precision, length of test, another testable proposition, or some combination thereof. Regardless, when the condition is satisfied, the procedure for stopping can be administrative (e.g., report the score to the hiring manager. Thank the applicant. Save the log files.).

The complexity of the CAT lies one level down, in the item selection rule 3240 and the scoring rule 3270. A possible item selection rule is described herein. “For scales (e.g., each scale), retrieve the expected reduction in variance from administering the next item, and multiply it by a point estimate of the sensitivity at 3243. For stand-alone items (e.g., each stand-alone item), obtain the expected reduction in variance by simulating each possible outcome 3241. At 3242, 3244, 3245, 3246, choose the item or scale which, in expectation, reduces the variance of the output by the greatest increment when one item is administered.”

The scoring rule may be stated more simply. “Estimate the mean outcome if this applicant is hired, by feeding the predictive model the known responses and different plausible values of the remaining data at 3271, 3272, 3273, 3274, 3275.” The scoring rule can loop until the imputation limit is reached. During processing, the standard error of mean (“SEM”) can be calculated.

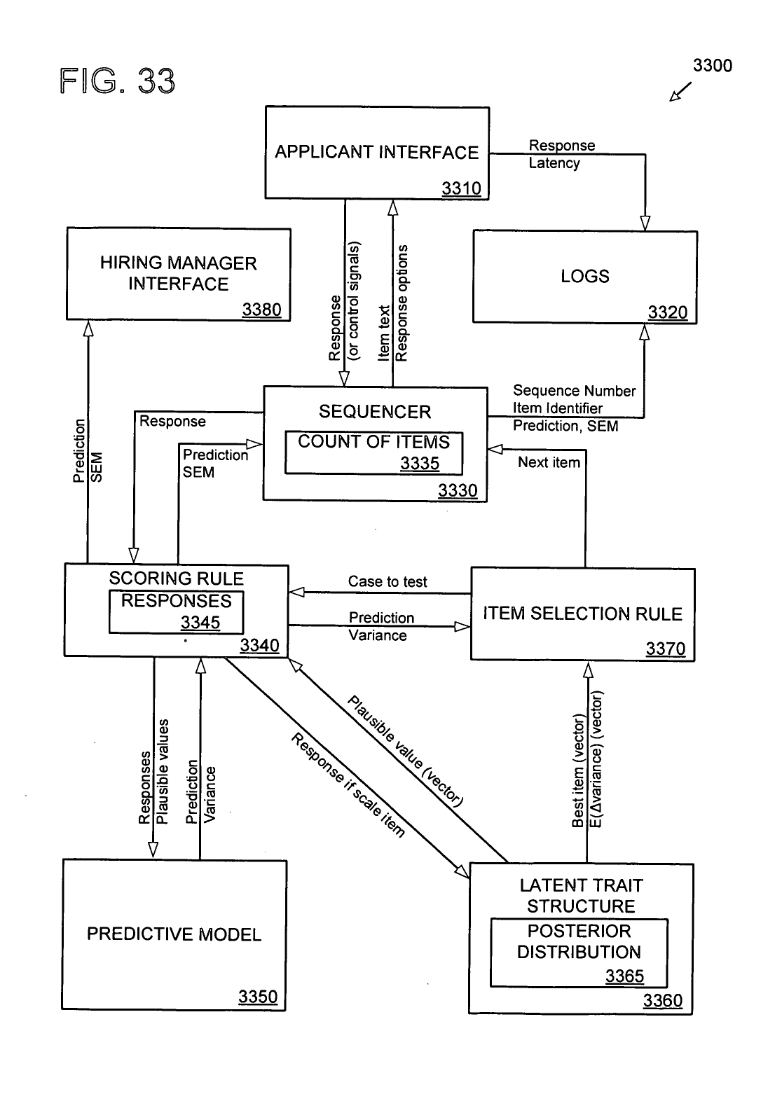

FIG. 33 is a dataflow diagram of an exemplary system 3300 for administering of an adaptive assessment. Another way to look at the architecture of the program is to consider the flow of information between functional units which maintain or access data structures and perform specified functions. FIG. 33 illustrates the complexity inherent in CAT, and particularly in a hybrid CAT. The functional units 3310, 3320, 3330, 3340, 3350, 3360, 3370 are labeled with a name and in some cases the primary data structure maintained by that functional unit. Arrows represent the flow of mathematically important information. Requests and function calls are not shown.

The applicant interface 3310 sends responses to the sequencer 3330. Response latency can be provided to the logs 3320. The responses are also considered by the scoring rule 3340. The predictive model 3350 can consider both responses and plausible values and provide prediction variance in return. Responses to scale items can be provided to the latent trait structure 3360, which can provide a best item to the item selection rule 3370, which in turn can provide the next item to the sequencer 3330. The prediction can be provided to the hiring manager interface 3380 for presentation to a hiring manager.

As shown in the example, the sequencer 3330 can maintain the count of items 3335. The scoring rule 3340 can maintain the applicant's responses 3345. The latent trait structure 3360 can maintain the posterior distribution 3365.

The stopping rule may be a specified precision, a score may be reported to the applicant, or an error of measurement may not be available (e.g., as in the case of a fixed test).

### Example 68

### Exemplary Applicant Interface

If desired, the applicant interface can have a few, simple functions. It can allow the applicant to begin the test (e.g., tell the sequencer to initialize and the log keeper to open a new file for the applicant). The applicant can also abort the test in an incomplete state. The interface can then reset itself for the next applicant.

The applicant interface can present items, instructions, and information such as legal statements, and allow the applicant to respond to open-ended as well as menu-type items. It can record the applicant's responses and response latencies to the logs, as well as passing the responses to the sequencer.

The applicant interface can be designed to have enough screen space to display the whole item, if desired. To avoid interfering with the measurement being attempted, the interface can be simple and clear. It may be desirable to prevent the applicant from multitasking, or requiring the computer to multitask. There are performance reasons for dedicated attention on both sides of the keyboard; performance issues are also described herein.

### Example 69

### Exemplary Sequencer

In any of the examples herein, the sequencer can be responsible for deciding when to invoke the starting, stopping, and continuing rules, as well as organizing the events within the continuing rule. The sequencer keeps a running count of items, or keeps track of the error of measurement, depending on the stopping condition. It can also be the primary source of data to be sent to the logs: the date and time started, the sequence number of the current item, the identifier and content of the item chosen, and the applicant's score.

When CAT is implemented in a procedural language, the sequencer function calls and dismisses the item selection rule and scoring rule each time the continuing rule loops; it can thus be responsible for maintaining, disseminating, and recovering a number of major data structures that it otherwise does not use, such as the posterior distribution vectors. It is more convenient for the purposes of discussion to associate those data structures with specific functional units at the “back end” of the program; different functions and persistent data structures can be referred to as attached to agents, such as the item selection rule.

In the continuing rule loop, the sequencer can test the stopping condition. If the condition is not met, the sequencer can ask the item selection rule for the next item and wait. Upon receiving an item identifier, it can report it to the log, tell the applicant interface to get a response, and wait. Upon receiving a response from the applicant interface, it can pass the response to the scoring rule, ask the scoring rule for a score, and wait. Upon receiving a score, it can pass the score on to the logs, then return to the beginning of the loop.

### Example 70

### Exemplary Logs

In any of the examples herein, the logs can include an agent responsible for ensuring that data passed to it is stored in an organized, safe and secure way. This may involve writing to a file, a database, or another structure. Logs can be combined with one or more other functional units.

The logs can receive data including item identifiers, responses, latencies, and scores on an ongoing basis from the applicant interface and sequencer; in order to comply with possible court orders, the data can be recorded such that they are not lost, even if the test is unceremoniously aborted, the power fails, or some other part of the program crashes.

### Example 71

### Exemplary Item Selection Rule

In any of the examples herein, the item selection rule can be invoked by the sequencer. The item selection rule can acquire two pieces of information, make a comparison, and output the identifier of an item. It need not maintain any data structures of its own from iteration to iteration.

The two pieces of information the item selection rule can use are the best possible expected reduction in variance due to administering an item, and the same quantity due to administering a scale. It does not matter which one it calculates first; they could be simultaneous if the language and supporting system permit threading. When both values are known, they are compared, and the item associated with the higher value is returned to the sequencer.

The best scale can be chosen according to the method described herein. In short, the item selection rule can ask the latent trait structure for a list of the best items from each scale, and the expected reduction in scale variance associated with each one. Then it multiplies each by the sensitivity of the output to that input and finds the highest result. The sensitivity may not be easy to calculate; for some parts it may be easier to run the neural network and record the final activations of the nodes.

The best item can also be chosen as described herein. This, however, can involve trying out each possible response to each yet-unadministered item by submitting the current responses plus that one to the scoring rule. The variance for responses (e.g., all responses) to remaining items (e.g., each remaining item) are averaged, using weights corresponding to response probabilities, and subtracted from the current variance (also calculated by the scoring rule) to produce the expected reduction in variance. In such a scenario, the best item is the one associated with the highest expected reduction in variance.

### Example 72

### Exemplary Scoring Rule

In any of the examples herein, the scoring rule can be invoked either by the sequencer or by the item selection rule. In these two cases, it can behave essentially the same, but for different purposes. In either case it can provide a prediction and an error of measurement. A difference is that the sequencer expects the prediction made for the current state of known responses, while the item selection rule asks about a hypothetical set of responses. The sequencer is likely to want the error of measurement as a standard error, whereas the item selection rule uses a variance, but it is possible to alter either functional unit to reverse the transformation if the scoring rule is programmed to only give one type of response.

The scoring rule can maintain a list of what response has been given to respective items, and the current best prediction with error of measurement. When the sequencer reports a new response, the scoring rule can determine whether it belongs to a stand-alone item or to a scale. If it belongs to a stand-alone item, the rule can update the list. If it belongs to a scale, it can pass the response on to the latent trait structure.

In either case, the scoring rule can update its score. It can search the list for default values, which represent missing data. A specified number of times, it can copy this list and fill in where data is missing, according to the rules of imputation: it can generate random values and filter them according to their likelihood. For the scale values, it can ask the latent trait structure to generate plausible values according to the same rules. When the copy comprises a complete set of inputs, the scoring rule can submit those inputs to the neural net and record the net's response. When the specified number of responses is accumulated, it can compute the mean and standard deviation (or variance), record them, and report them back to the sequencer.

The same procedure can be carried out when the item selection rule offers a hypothetical next response, except that an additional temporary copy of the current responses table can be generated. This way, the actual current values can be reset at the end, so that the hypothetical response is not mistaken for a real one.

The scoring rule, either on its own (e.g., every time) or through the sequencer (e.g., once) can also supply the final score to the hiring manager.

### Example 73

### Exemplary Latent Trait Structure

In any of the examples herein, the latent trait structure, which can be based on the subordinate CAT referred to herein, can respond to either the item selection rule or the scoring rule, providing them with two quite different pieces of information. The latent trait structure can maintain the posterior distribution.

The item selection rule can use two vectors maintained by the latent trait structure, the list of the best next item for each scale and the list of expected reductions in variance upon administering one item from each scale. Because these vectors are maintained, they need not be calculated at the time they are used. In fact, it can be more efficient to update these vectors, as well as the posterior distribution, each time a scale item response is passed over from the scoring rule.

The scoring rule can also use, at a different time, a list of plausible values, one for each scale. Plausible values can be constructed by the same generate-and-filter method used by the scoring rule, using the posterior distribution for that scale to determine the likelihood of a given generated value.

The first time the latent trait structure is invoked, before any items have been presented, it can generate a prior distribution. This is a different name for the same matrix which will later be called the posterior distribution; it need not be kept separate. Assuming the joint distribution is not known and the scales are treated as independent, this distribution can be written as a matrix with S rows. For example, each contains Q values, representing the height of the marginal distribution at Q quadrature points centered around 0, such as every 0.1 from −3 to 3. The heights can be generated according to either the empirical distribution observed for each pattern of biodata, or a theoretically reasonable distribution, such as the normal distribution with its parameters adjusted according to the biodata.

Subsequently, for each response given, the item characteristic curve corresponding to that response can be convolved with the marginal distribution for the corresponding scale. The item characteristic curve can be represented as a vector of likelihoods according to the same quadrature; the product of each member of the two vectors can then be taken. The result is the posterior distribution for that scale, and the distribution matrix is updated with the new values.

The best next item for a scale s may be chosen by finding the highest expected information gain. The expected information gain is approximated as the dot product of the sth row of the posterior distribution matrix and each item's information curve. Item information curves can be represented as a vector of heights corresponding to the same quadrature.

For each scale, the expected reduction in variance corresponding to that best item can be calculated. This can be done by finding the exact reduction in variance associated with possible responses (e.g., each response), and computing a weighted average according to the likelihood of the responses (e.g., each response). This vector, along with the list of best items, can be maintained until the item selection rule needs it.

### Example 74

### Exemplary Predictive Models

In any of the examples herein, a predictive model can comprise a neural network. The neural network can be configured in any of a variety of ways. The neural network need not maintain any data structures, although it can use a network of weights and biases which it generated in its training period. The neural network can take a standard list of inputs on which it has been trained, and return one or more predictions, one for each outcome it was trained to predict. Training can be done with biographical items, test items (e.g., adaptive items), or both. There can be more than one prediction made in a single run of the neural network. The neural network need not be aware of uncertainty and need not output an error estimate; imputation and aggregation of multiple trials can occur in the scoring rule.

The neural network computation can have three parts, of which the middle part is an iterative loop. First, it can preprocess the inputs, for example dividing a categorical variable into a series of binary variables, one representing each category. The network may also normalize continuous variables into a small range near zero; if this occurs, it can be reflected in the sensitivity calculation.

Once the inputs are preprocessed, the activations of the neural network nodes may be computed, one layer at a time. This can be accomplished in software, being a systematic weighted summation. Finally, the program can read off the value of the output node and deliver it back to the scoring rule.

### Example 75

### Exemplary Predictive Models

Optimization can be considered. For example, one can consider what constitutes an acceptable delay between items, as this can limit the calculations that can be done at that time. The calculations which are done to make the test effective can be completed within that time. A compromise can weigh the need for processor-intensive procedures against the increase in computational demand associated with them. Some suggestions follow for improving performance.

How much of a delay is permissible (e.g., 1 second, 2 seconds, some other value)? Tests can be administered over the Internet. Between items, there is already a delay associated with data transfer and web page rendering, which does not come as a surprise to the applicant. The length of this delay depends greatly on the actual Internet connection available to the applicant. However, it is likely that an additional second, or even few seconds, of processing would be lost in this expected delay.

Any appropriate computing language can be chosen. The R language can be used, with readability in mind; however more efficient languages (e.g., C) can be used. The neural net can be in C and called from R; standard code can be generated by the neural network module of Statistica 6 software and it can be unnecessary to duplicate its function.

The number of imputations required to achieve consistent estimates of the likely prediction and error of measurement is likely to vary according to the structure of the neural net. One that fits the data well, with a wider range of sensitivity values, will require fewer iterations to achieve reliable results. The system can be reduced to a threshold number of (e.g., 500, a higher number, or a lower number) imputations per estimation without incident.

Another approximation that may be made coarser for the sake of efficiency is the vector representation of each posterior distribution, item characteristic curve, and item information curve. If relatively few items are available for each subscale, it is unlikely that any given latent trait will ever be known to the precision normally associated with CAT. If fine distinctions on the order of a tenth of a standard deviation will never be made because of the items available, there is no particular reason that the resolution of the discrete representation should be greater. Two tenths of a standard deviation may well be acceptable, if one's interest is only in separating those applicants who are high on the trait from those who are low on it. This speeds up calculations involving the posterior distribution, of which there can be many.

There are further optimizations that can streamline the calculation and approach the “few seconds” performance. In an operating environment that allows threading, the maintenance processes of the latent trait structure, including updates to the posterior distribution and the look-ahead procedure that gives the next item and expected reduction in variance, may be shunted to a second thread. If a second processor is available, it may be used, and the complexity of the subordinate CAT need not be as limited.

### Example 76

### Exemplary Execution

A hybrid, neural net-based CAT can be used. Results of execution confirm that a system can have the benefits of an adaptive test. That is, the test can be shorter with little loss of validity; “little loss” will be defined in relation to a uniform or random reduction of the test. The test can report its own error of measurement accurately. The test need not administer the same items to all applicants.

In order to verify that the hybrid CAT meets these requirements, a fully trained neural net was developed. A partial simulation procedure, in which data from applicants who took the test under non-adaptive conditions was requested one item at a time by the adaptive test, which permits immediate comparison within an individual of the effect of different testing procedures.

Data from 3,989 employment applications were used for the partial simulation. Applicants in the sample were hired at the national retail chain to which these applications were submitted; no criterion data was available for applicants not hired, so their data was not used.

Performance data were collected over one month. The sample population was employed during that one month period and had been employed for at least one month.

The performance dimension measured was sales productivity. The dollar amount of sales attributable to an employee was routinely tracked by the company and compared on a monthly basis to a sales goal. For this example, that dollar amount of sales was divided by the number of hours worked to provide a sales-per-hour figure. Sales per hour were then normalized within equivalent groups defined by job class, in order to limit the “noise” introduced by environmental factors not related to individual personality characteristics.

Each store employs several sales associates, and one or more cashiers, stockers, and managers. Sales associates made up the bulk of the sample, but the other jobs were also represented. There is expected to be employee movement between jobs, so it is typically not practical to extensively distinguish between the requirements of one job and those of another when considering a candidate for employment.

Slightly more than half the sample (50.1%) reported being male; 4.6% omitted the question. No single race made up the majority of the sample; 39% reported being African-American, and 37% reported being Caucasian. 4.7% omitted the question, and other races made up the remainder.

### Example 77

### Exemplary Predictive Models

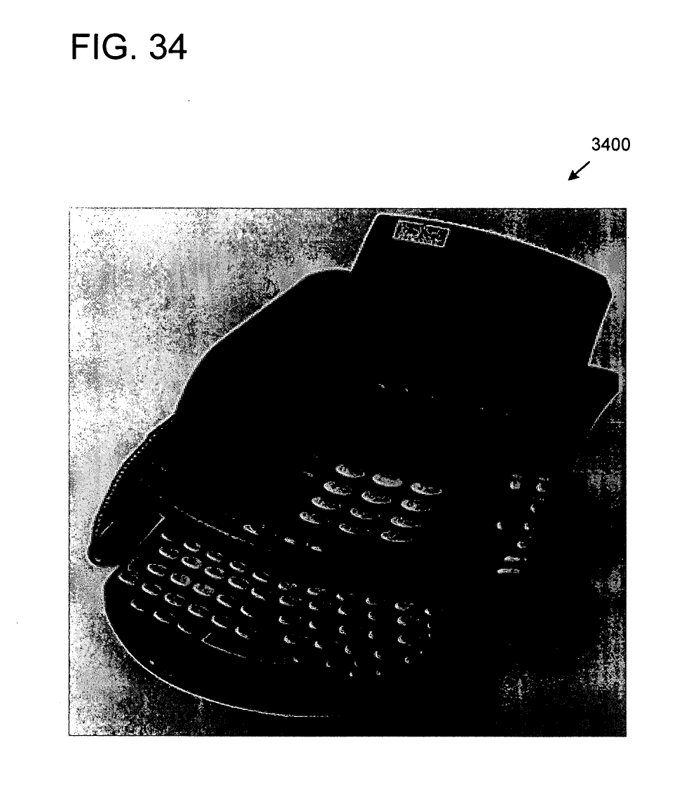

The applicants responded to the same form of a Sales test, a test designed to predict success in floor sales through several behaviors. The test was administered in one of two modes. Single-purpose kiosks were available inside store locations; the custom devices in the kiosks are referred to as “screen phones.” FIG. 34 shows an example of a screen phone 3400. Applicants with access to the Internet could also apply at a Web site, and take the test within their Web browsers. The display capabilities of a screen phone are typically not as sophisticated as those of a Web browser, but the input device is better defined.

These technical differences resulted in separate implementations of the test, and resulted in different user experiences. In addition, the device used to submit an application implies one of two test-taking environments: the store to which the application is being submitted, and a user-chosen location which likely afforded more privacy and comfort. Application mode was retained in order to provide context to other data obtained.

As its name might imply, the Sales test was expected to predict job performance in a customer-facing, selling environment. Dollar value of sales is a reasonable criterion measure against which to measure the Sales test.

Each of the tests measures several traits, on the principle that multiple behaviors may lead to the same business outcomes. The Sales test was designed to measure sociability, dominance, adaptability, optimism, and the applicants' own estimates of their on-the-job effort and practical intelligence. These traits are implicitly assumed to be compensatory, but in an arbitrary fashion; the test was only loosely balanced to have equal numbers of these items, and was refined according to empirical correlations.

Of the 80 items on the test, 49 were sorted into 7 reliable subscales and validated across multiple data sets and multiple organizations. The data set at hand was not used in subscale development. The apparent central constructs of the subscales and the expected constructs on the tests matched fairly well, but not perfectly. Most significantly, the applicants' judgments of their own ability and effort were highly correlated; the applicants had a general level of self-efficacy which they expressed on the valenced items. Whether this characteristic amounts to the desire to “fake good” or merely self-esteem, it was not separable into one opinion about ability and one about effort.

Other constructs, such as sociability, dominance and adaptability, were clearly separable. Dominance, in fact, was split into separate scales for leadership ambitions and leadership-relevant traits, correlated about 0.4. Because of the several distinct scales, a one-factor model was not supported for the overall test.

Thirty-one items remained as unique items after scales were constructed. These items represented a combination of items thought to be complex and items that tapped underrepresented constructs.

Of the numerous available biographical data, seven items were chosen according to the following pragmatic criteria. The items were required to have a finite (and small) number of possible responses, such as those chosen from a list; free response items were not allowed. Items about membership in protected classes were not used. Items were also not used if they could be used to identify the region from which an application originated; it is not useful to know whether New England employees perform better than California employees, because positions must be filled in all regions. Of the items that passed those three tests, the highest possible amount of criterion variance they could explain was determined by an information theoretic procedure; a list was made of those which were informative either singly or jointly. Highly collinear items were dropped from the list. Finally, one item was added which had been observed to have higher-order effects in a previous sample: application mode. The result was a list of seven biographical items.

### Example 78

### Exemplary Neural Network

The sample was divided into one training sample and two holdout samples by independent random assignment of each case. 2,950 applications were assigned to the training sample; 648 and 391 were assigned to the holdout conditions, for an approximate 75/15/10 split.

Item parameters were obtained for the scales to be used by the subordinate CAT. Data for this process were drawn from a non-overlapping sample of 97,563 applicants at a retailer expected to have a similar sales environment. It was anticipated that hires at one or both chains might differ on the scale constructs, but applicants were likely to be similar.

The nominal model was applied to each group of items expected to form an internally consistent univariate scale. The nominal model is an item response model which predicts the likelihood of each of several responses, usually multiple-choice, given the level of a single latent trait. Although the items were Likert scales, the nominal model provided a superior fit compared to constrained models such as the rating scale model and graded response model.

A three-layer perceptron was trained on the training sample, using 7 scales, additional items, and 7 biographical data as inputs, and 12 hidden nodes. The number of hidden nodes is not known to be optimal, but is not unreasonable given the number of training cases. The network was fully connected; weights were established through one hundred iterations of backpropagation, with a momentum coefficient of 0.3, followed by refinement through conjugate gradient descent. To avoid overfitting, on each iteration, noise was added to the inputs. The noise was distributed normally with mean 0 and standard deviation 0.1. The first holdout sample was also used to test whether overfitting had occurred.

After 100 iterations of backpropagation and 21 of conjugate gradient descent, the network appeared to have found either a local or global minimum; the fit of the network to the data stopped improving noticeably. Overfit was not evident; the correlation with actual outcomes was 0.123 in the training sample and 0.121 in the first holdout sample, so the network was accepted. The fit of the network to the data was relatively poor for this application, indicated by the low correlation in both the training and first holdout samples. However, the fit was sufficient that the network weights were likely to be meaningful.

### Example 79

### Exemplary Technique

The effectiveness of the item selection method was tested on the first hundred cases from the second holdout sample, selected sequentially by application date. Predictions of per-hour sales were made for these cases under five conditions. In the “all data” condition, each case was fed to the neural net with no missing data and its prediction recorded. In the two “adaptive” conditions, a mock user interface submitted the required biodata items to the CAT, which was then allowed to choose a specified number of items (10 or 20) according to its methodology. As each item was chosen, the mock user interface reported the actual response to the CAT; a prediction was made without the remaining items. Finally, in the two corresponding “random” conditions, an equal number of items were chosen at random and the rest considered missing. Estimation in the random conditions was performed by the method of multiple imputations, as in the adaptive conditions, but the informed item selection routines were disabled.

### Example 80

### Exemplary Results

To see whether this testing process has the expected benefits of an adaptive test, four questions were asked. First, is a prediction following adaptive selection more accurate than one made following the same number of items administered at random? Second, is the error of measurement reported by the test program reflective of the actual error in estimation of the final prediction? Third, is the test in fact adapting, or simply recognizing that certain items are universally more informative than others? Finally, how many items need be administered before the adaptive test delivers a reasonable approximation of the prediction made with full information?

To the first question, it may be conclusively stated that the adaptive item selection algorithm results in an improvement over random item administration. The absolute value of the difference between predictions in the adaptive and all data conditions was less than that between predictions in the random and all data conditions (Table 1B; p=0.03 for 10 items and p=0.0002 for 20). The reported standard error of measurement was lower in the adaptive case at ten items and at twenty items (Table 2B; p<0.00001 in both cases). Correlation with predictions in the all data case was higher for the adaptive case at both test lengths (Table 3B; p<0.05 in both cases).

Is the error of measurement reported by the test program reflective of the actual error in estimation of the final prediction? One would expect the absolute differences between the test's predictions and the fully informed predictions, divided by the reported standard error of measurement, to be distributed with standard deviation one. At both test lengths, they were distributed with standard deviation 1.12, indistinguishable from 1 at 100 cases. In the absence of contradictory evidence, we may assume that the standard errors of measurement reported by the program are reflective of actual precision. Oddly, the partially informed predictions were biased toward a lower performance than the fully informed predictions. This bias may stem from the use of a prior distribution based on the applicant population for latent trait estimation in the cases of persons already known to be selected as employees. Some selection had been done for better traits, which was not taken into account by the test. The bias was lower in the 20-item case than the 10-item case, indicating slow convergence.

TABLE 1B
Mean absolute difference from the “all data” condition.

| Test length | Adaptive condition | Random condition |
|---|---|---|
| 10 items | 0.097 (0.084) | 0.116 (0.099) |
| 20 items | 0.086 (0.074) | 0.115 (0.099) |

TABLE 2B
Mean standard error of measurement as reported by the test.

| Test length | Adaptive condition | Random condition |
|---|---|---|
| 10 items | 0.108 (0.017) | 0.131 (0.009) |
| 20 items | 0.092 (0.020) | 0.129 (0.010) |

TABLE 3B
Correlation with “all data” condition.

| Test length | Adaptive condition | Random condition |
|---|---|---|
| 10 | 0.60 (0.08) | 0.21 (0.10) |
| 20 | 0.70 (0.07) | 0.22 (0.10) |

Is the test in fact adapting to individuals? It is possible for an item selection algorithm to outperform random item administration simply because some items are always more useful than others. In order to determine whether this is the case, one can examine the frequency of administration of different items. Only one item was given to every applicant at both test lengths, and not always in the same ordinal position. Some items appeared relatively frequently, while 21 items never appeared in either condition, suggesting that there are some items which are more useful for a broad range of applicants than other items. This result suggests that the test is indeed adapting.

How many items are enough? In a practical situation, a decision must be made about how long the new adaptive test must be in order to deliver a reasonable approximation of the fully informed result. This decision hinges on what it means to be a reasonable approximation. The approximation will necessarily lower the criterion validity coefficient of the test, but is a reduction of 0.01 acceptable? 0.02? 0.05? Let us assume that the true validity of the test is known to a certain precision, based on testing with a holdout sample.

Let us then propose a rule of thumb: a reduction in validity which is less than the standard error of estimation of the validity coefficient is a reasonable approximation. By this rule of thumb, if the fully informed prediction had a validity coefficient of 0.20 with an error of estimation of 0.02, an adaptive test's prediction must correlate at least 0.90 with the fully informed prediction in order to be sufficient. If the neural net were trained to a validity of 0.30 with the same error of estimation, the prediction must correlate 0.93 in order to be acceptable.

The neural network was trained to a much lower validity, 0.12, atypical in practice. By the rule of thumb, the correlation of 0.70 achieved in the twenty (20) item condition was insufficient even at this level of validity. A longer test, for example thirty (30) items, could be used. However, even the twenty (20) item test proved to be superior to giving a random twenty (20) items to applicants, so it met the goal of reducing the size of the test while avoiding a corresponding decrease in accuracy.

The adaptive test was about 30% better compared to random shortened tests based on standard error of measurement and about 25% better in terms of absolute difference (e.g., a subtractive comparison of the estimated score with a score given when all eighty items were administered).

### Example 81

### Exemplary Information

Although some examples focus on application to the problem of predicting sales performance, the technologies can be generalized to other problems and alternative network architectures.

A neural network designed to recognize patterns leading to positive employment outcomes can be combined with a process that gathers the predicted best information for improving its prediction, given constraints on the quantity of inputs allowable. The resulting hybrid can function according to the expectations placed on neural networks as well as those placed on adaptive tests.

The system can model an arbitrary output function over an arbitrarily multidimensional input space. It can be efficient: it can achieve a much shorter test with relatively little loss of precision. It can report its own error of measurement: the error of estimation of a prediction can be scaled according to the validity of the prediction to give an error of estimation of the outcome. It permits comparison of applicants who did not answer the same items: it places them on a common scale in terms of the predicted outcome, even if available item content is changed or the neural model is revised.

The neural network-based testing architecture can take the form of adaptive testing where multiple traits are simultaneously estimated. For example, the system can maintain a latent trait structure involving seven separate traits, although it does not report a profile of scores. Such a profile can be reported.

### Example 82

### Exemplary Further Information

In any of the examples herein, the technologies can be implemented in an industrial psychology application (e.g., using a neural network in a computerized adaptive test). Assessments (e.g., tests) can include a variety of content types: cognitive, personality, biodata, or some combination thereof. The assessments can be used to decide between potential employees.

In practice, a service provider can provide a service to a company to put a computerized kiosk in the company's store (e.g., a store in a retail chain), on a page of a web site (e.g., of the service provider or company), or both. People can apply for jobs at the kiosk or web site. In this way, if someone goes to one of the company's stores, the person need not fill out a paper application. This avoids problems with handwriting. The kiosk can employ the screen phone shown herein or a general purpose computer system.

The automated techniques described herein can be advantageous because a hiring manager can be given a score right away. The assessment can predict how well the employee would perform if the employee were to be hired. Such predictions (e.g., any of the outcome variables described herein) can have real dollar values attached.

In some cases, most applicants may have the brainpower to perform tasks for the job, but perhaps the willingness to perform is absent. So, a personality assessment can be included. The personality assessment in combination with background, education, and job history can give a useful prediction of performance (e.g., via neural network). Psychological and biographical variables can be combined to predict any of the outcome variables described herein. Nonlinearities (e.g., a little anxiety is good, but not too much) can be modeled.

In any of the examples herein, the assessment can be adaptive. In such a case, the first answers a test taker gives influence what items the test taker will receive later in the assessment. An automated form of item response theory and Bayesian estimation can be used to better match the next item to the person taking the assessment.

For example, if a latent trait is being measured, the assessment can begin with moderate difficulty and adjust up or down based on performance.

By applying the techniques described herein, shorter (e.g., significantly shorter) test can be given while having useful results. A long test may lead to applicants who do not finish or complain, thus good people may be lost. Applicant complaints are typically specifically be aimed at the test questions rather than biodata questions. So, complaints may suggest the test be reduced from 100 to 80 or from 170 to 160 items. The technology herein can provide a prediction having the same effectiveness as such a test, but only present thirty (30) items.

Even though different items are administered to different applicants, the techniques described herein still allow mathematically valid comparisons between applicants and provide a measure of confidence in the score.

A predictive model such as a neural network can be used as a substitute for item response theory estimation. If different personality traits are being measured, they can be prioritized, given current knowledge (e.g., the answers to previous items). An item for the highest priority personality trait can be asked first.

The sensitivity of the neural network to different inputs can be used to choose the next input (e.g., sometimes called “the next most important input”). The sensitivity will change depending on what other inputs have been introduced and what their values are, so using such an approach for choosing items to be administered lets the test adapt to the applicant. Such an approach can be an improvement over a linear regression.

In any of the examples described herein, an assessment can take the following exemplary design: First, ask biographical questions, then ask (e.g., 20 or so items) the most informative item not yet presented based on the biographical information and any items already asked. The most informative question can be determined by simulating possible answers to questions that have not yet been asked and seeing which question, on average, reduces the error of estimation the most (e.g., which question not yet asked incrementally accounts for the most variance). Questions redundant to one already asked can be filtered out. A prediction of job performance can then be reported.

Having too many inputs to a predictive model can lead to poor performance (e.g., it can be harder to get a neural network to generalize and use the inputs efficiently, given available cases). If desired, the number of inputs to a predictive model can be reduced by collapsing highly correlated items into latent traits (e.g., scales) to be estimated. The resulting trait scores can be used as inputs to the neural network.

The techniques described herein can model an arbitrary business outcome based on complex opportunistic data. They can reduce testing time (e.g., by reducing redundancy). They can know an report error or measurement. They can permit comparison of applicants who took different tests because they can have predictions on the same scale.

### Example 83

### Exemplary Output of Predictive Model

In any of the examples herein, a predictive model can be constructed so that it generates any of a variety of outputs. For example, a neural network can output a continuous variable, a ranking, an integer, an n-ary (e.g., binary, ternary, or the like) variable (e.g., indicating membership in a category), probability (e.g., of membership of a group), percentage, or the like. Such outputs are sometimes called bi-valent, multi-valent, dichotomous, nominal, and the like.

Any of the assessment outputs described herein can be based on the output of one or more predictive models. For example, a predictive model output can be used as an assessment output, or the assessment output can be calculated from the predictive model.

The output of the neural network is sometimes called a “prediction” because the neural network effectively predicts a job performance outcome for the candidate employee if the candidate employee were to be hired. Any of a variety of outcome variables can be predicted. For example, performance ratings by managers, performance ratings by customers, productivity measures, units produced, sales (e.g., dollar sales per hour, warrantee sales), call time, length of service (e.g., tenure), promotions, salary increases, probationary survival, theft, completion of training programs, accident rates, number of disciplinary incidents, number of absences, separation reason, and whether an applicant will be involuntarily terminated can be predicted.

Neural networks are not limited to the described outputs. Any post-employment behavior (e.g., job performance measurement or outcome) that can be reliably measured (e.g., reduced to a numeric measurement) can be predicted (e.g., estimated) by a neural network for a candidate employee. It is anticipated that additional job performance measurements will be developed in the future, and these can be embraced by the technologies described herein.

The output of a neural network can be tailored to generate a particular type of variable. For example, an integer or continuous variable can be converted to a binary or other n-ary value via one or more thresholds.

### Example 84

### Exemplary Computing Environment

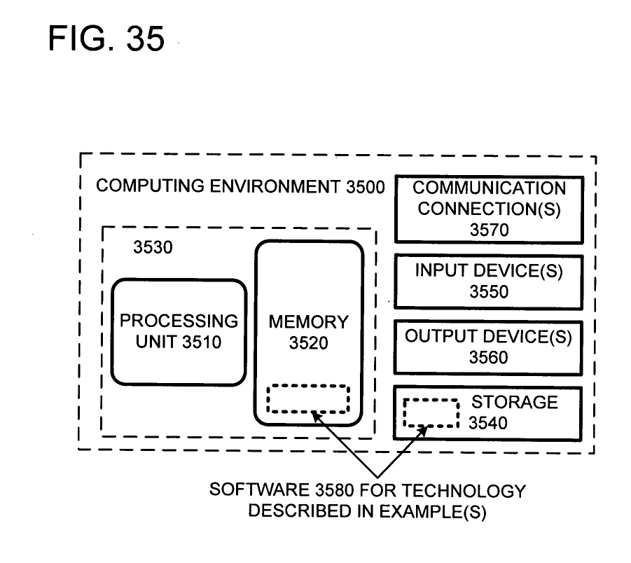

FIG. 35 illustrates a generalized example of a suitable computing environment 3500 in which the described techniques can be implemented. The computing environment 3500 is not intended to suggest any limitation as to scope of use or functionality, as the technologies may be implemented in diverse general-purpose or special-purpose computing environments.

In FIG. 35, the computing environment 3500 includes at least one processing unit 3510 and memory 3520. In FIG. 35, this most basic configuration 3530 is included within a dashed line. The processing unit 3510 executes computer-executable instructions and may be a real or a virtual processor. In a multi-processing system, multiple processing units execute computer-executable instructions to increase processing power. The memory 3520 may be volatile memory (e.g., registers, cache, RAM), non-volatile memory (e.g., ROM, EEPROM, flash memory, etc.), or some combination of the two. The memory 3520 can store software 3580 implementing any of the technologies described herein.

A computing environment may have additional features. For example, the computing environment 3500 includes storage 3540, one or more input devices 3550, one or more output devices 3560, and one or more communication connections 3570. An interconnection mechanism (not shown) such as a bus, controller, or network interconnects the components of the computing environment 3500. Typically, operating system software (not shown) provides an operating environment for other software executing in the computing environment 3500, and coordinates activities of the components of the computing environment 3500.

The storage 3540 may be removable or non-removable, and includes magnetic disks, magnetic tapes or cassettes, CD-ROMs, CD-RWs, DVDs, or any other computer-readable media which can be used to store information and which can be accessed within the computing environment 3500. The storage 3540 can store software 3580 containing instructions for any of the technologies described herein.

The input device(s) 3550 may be a touch input device such as a keyboard, mouse, pen, or trackball, a voice input device, a scanning device, or another device that provides input to the computing environment 3500. For audio, the input device(s) 3550 may be a sound card or similar device that accepts audio input in analog or digital form, or a CD-ROM reader that provides audio samples to the computing environment. The output device(s) 3560 may be a display, printer, speaker, CD-writer, or another device that provides output from the computing environment 3500.

The communication connection(s) 3570 enable communication over a communication medium to another computing entity. The communication medium conveys information such as computer-executable instructions, audio/video or other media information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Communication media can embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. Communication media include wired media such as a wired network or direct-wired connection, and wireless media such as acoustic, RF, infrared and other wireless media. Combinations of any of the above can also be included within the scope of computer readable media.

The techniques herein can be described in the general context of computer-executable instructions, such as those included in program modules, being executed in a computing environment on a target real or virtual processor. Generally, program modules include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing environment.

### Example 85

### Exemplary Other Techniques

Any of the techniques described in Scarborough et al., U.S. patent application Ser. No. 09/922,197, filed Aug. 2, 2001, and published as US-2002-0 046 199-A1, which is hereby incorporated by reference herein, can be used in any of the examples described herein.

### Alternatives

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. I therefore claim as my invention all that comes within the scope and spirit of these claims.

I claim:

1. A method comprising:
administering an assessment to a candidate employee;
receiving an answer to at least one question presented to the candidate employee during administration of the assessment;
based on the answer to the at least one question, selecting, during administration of the assessment, in view of the answer to the at least one question, a next question out of a set of possible questions for presentation to the candidate employee based on an expectation of reduction in assessment output variance if the next question were to be answered;
presenting the next question to the candidate employee; and
outputting at least one assessment output.

2. The method of claim 1 wherein the expectation of reduction in assessment output variance is determined by applying plausible values to at least one of a plurality of inputs to a predictive model for one or more respective questions not yet answered by the candidate employee while constraining an other of the inputs for a question not yet answered by the candidate employee.

3. The method of claim 2 wherein:
the plausible answers are chosen at random according to an observed distribution of answers for one or more questions by other candidate employees.

4. The method of claim 3 wherein different sets of random answers for questions not yet answered are applied to a neural network to estimate output variance.

5. The method of claim 2 wherein the expectation of reduction in assessment output variance is calculated as a weighted average for a plurality of possible answers to the constrained input.

6. The method of claim 2 wherein the predictive model comprises a neural network.

7. The method of claim 6 wherein:
fewer than all inputs are available to the neural network; and
an output value for the neural network is used to calculate one or more of the at least one assessment outputs.

8. The method of claim 2 wherein expectation of reduction in assessment output variance if the next question were to be answered is calculated for a group of questions designated as for determining a latent trait.

9. The method of claim 1 wherein a value for the latent trait is used as an input to a predictive model for calculating one or more of the at least one assessment outputs.

10. The method of claim 1 further comprising:
electronically receiving answers to one or more biographical questions to the candidate employee;
wherein the next question is selected based at least on the answers to the one or more biographical questions.

11. The method of claim 1 further comprising:
stopping the assessment when the expectation of reduction in assessment output variance drops below a threshold.

12. One or more computer-readable media comprising computer-executable instructions for performing the method of claim 1.

13. A method comprising:
for a set of a plurality inputs to a predictive model operable to output an assessment output, applying random values to one or more of the inputs and observing a resulting first variance in the output;
constraining at least one of the one or more inputs while applying random values to other of the one or more of the inputs and observing a resulting second variance in the output;
calculating a reduction in variance; and
based on the reduction of variance, selecting a question associated with the input for presentation to a job applicant during an assessment.

14. The method of claim 13 wherein:
the constraining comprises constraining the at least one of the one or more inputs to respective possible answers for the at least one input of the one or more inputs;
the calculating a reduction in variance comprises estimating variances for the respective possible answers; and
the calculating a reduction in variance further comprises estimating the second variance in the output via a weighted average of the variances for the respective possible answers.

15. A method comprising:
administering an assessment to a candidate employee, wherein the assessment outputs at least one assessment output; and
during the assessment, choosing a next question to present to the candidate employee based on answers to one or more other questions already presented during the assessment;
wherein the assessment output is based on a value indicative of a measure of at least one personality trait for the candidate employee relative to other candidate employees already tested.

16. The method of claim 15 wherein choosing the next question comprises determining which question would reduce estimated variance most if the answer to the question were available.

17. A method comprising:
identifying an item out of a set of possible items as having greater predictive power than an other item out of the set of possible items; and
presenting the item as part of a job effectiveness assessment for response by a candidate employee.

18. The method of claim 17, wherein:
the identifying comprises measuring sensitivity of a predictive model for an item not yet presented.

19. The method of claim 18, wherein:
the identifying further comprises choosing an item for which the predictive model exhibits a greater sensitivity.

20. The method of claim 17, wherein:
the identifying comprises applying possible responses to a predictive model for an item not yet presented.

21. The method of claim 20, wherein:
the identifying further comprises measuring change in prediction by the model across the possible responses for the item not yet presented.

22. The method of claim 21, wherein:
the identifying further comprises choosing an item having a greater change in prediction.

23. An adaptive assessment tool comprising:
means for collecting answers to questions from a candidate employee;
means for choosing a question from a set of possible questions according to an adaptive selection technique based on previous answers to questions by the candidate employee, whereby the question is a chosen question;
means for administering one or more administered questions, wherein the means for administering is responsive to the means for choosing and is configured to administer the chosen question; and
means for indicating an assessment result of the candidate employee based on answers by the candidate employee to the one or more administered questions.
